(19) United States
(12) Patent Application Publication
(10) Pub. No.: US 2021/0049710 A1
(43) Pub. Date: Feb. 18, 2021

(54) SYSTEMS AND METHODS FOR SELF AND SOCIAL DISCOVERY

(71) Applicant: Unveil.Social, SBC, Minneapolis, MN (US)

(72) Inventor: Russell HAYWOOD, Minneapolis, MN (US)

(73) Assignee: Unveil.Social, SBC, Minneapolis, MN (US)

(21) Appl. No.: 16/995,708

(22) Filed: Aug. 17, 2020

Related U.S. Application Data
(60) Provisional application No. 62/888,403, filed on Aug. 16, 2019.

(51) Int. Cl. G06Q 50/00; G06Q 30/08; G06Q 30/02

(52) U.S. Cl. CPC G06Q 50/01; G06Q 30/0204; G06Q 30/0203; G06Q 30/08

(57) ABSTRACT

Novel and advantageous tools for self-discovery and social discover are provided. In particular, systems and methods for privately testing mutual relationship possibilities and alignments are provided. Such systems and methods may be used for developing a profile including creating one or more personas, establishing a relationship intent within each persona, and developing expectations within the relationship intent are provided. The systems and methods may further be used for identifying where a first user and a second user have a matching relationship intent within a matching persona, pairing the first user and the second user upon approval for a connection by both the first user and the second user, identifying where the first user and the second user have aligned expectations within the matching relationship intent, and sharing the aligned expectations with the first user and the second user.

### FIELD OF THE INVENTION

The present disclosure relates to novel and advantageous tools for self-discovery. In particular, the present disclosure relates to systems and methods for building a virtual representation and analysis of a user's whole self. Additionally, the present disclosure relates to novel and advantageous tools for social discovery for connecting with other users. In particular, the present disclosure relates to systems and methods for privately testing mutual relationship possibilities and alignment.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Relationships are key to one's professional and personal ability to thrive. However, relationships of all types are not easy to discover, vet, and maintain. An individual's critical needs, wants, and opportunities often remain hidden from other individuals/entities who might be eager to engage but lack the openings to transact. As a result, our personal lives, and by extension, our very civilization, operates below their potential to fully thrive.

Normal relationship vetting and testing unfolds one relationship intention at a time. A relationship intention or relationship intent is the broad goal of a relationship. For example, in the context of a romantic relationship, the relationship intent may be a casual relationship or serious relationship. Once a relationship intention between two people is tested--and fails--often more sustainable relationships suffer. (e.g. testing romance at work, testing spirituality with friends, testing politics with family). To be safe, in general, people simply do not test new relationship types often, if at all. As there is no way to safely and quickly test the sustainability/alignment of the many unknown possible relationship intentions at once

Moreover, in current online and application-based social connection platforms, problems stem from users' inability to maintain control and ownership over their own data. Centralized databases of user data are frequently subject to cyber-attacks. User data is commonly sold and shared without the users' knowledge or express consent as to where that data is going or how it may be used. This can lead to more vulnerabilities and opportunities for fraud.

The lack of data security and privacy has an additional quieting effect: Physiological safety is diminished when users do not trust who is viewing their personal data. When users do not feel 100% safe and secure in how their data is captured and shared, the honesty and integrity of their data weakens. Weak and obscure data from users makes digital discovery and alignment or compatibility testing between users, at best, less accurate and more inefficient—and at worst, impossible.

Great inefficiencies exist in the “social marketplaces” where humans live, work, and play. Commodity and stock markets have clear buyers and sellers transacting their needs and wants on secure, stable, and regulated platforms. However, our “social marketplaces” (churches, workplaces, schools, neighborhoods) have no efficient, clear, honest, and safe platforms for the exchange of social needs beyond tradition, habit/bias, and organic happenstance.

A need exists for a safe and secure platform for users to explore relationship intentions and discover alignments.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a method for social discovery. The method may include providing a platform on which a user can develop a profile. Developing the profile may comprise creating one or more personas, establishing a relationship intent within each persona, and developing expectations within the relationship intent. The method further includes identifying where a first user and a second user have a matching relationship intent within a matching persona, pairing the first user and the second user upon approval for a connection by both the first user and the second user, identifying where the first user and the second user have aligned expectations within the matching relationship intent, and sharing the aligned expectations with the first user and the second user.

The present disclosure, in one or more embodiments, additionally relates to a system for self and social discovery. The system comprising a self-discovery module for facilitating self-discovery and a social discovery module for facilitating social discovery. The self-discovery module may include a persona manager and an intent manager. The self-discovery module facilitates creating one or more personas, establishing a relationship intent within each persona, and developing expectations within the relationship intent. The social discovery module may include an insight engine, a matching engine, and a connection manager. The social discovery module facilitate identifying where a first user and a second user have a matching relationship intent within a matching persona, pairing the first user and the second user upon approval for a connection by both the first user and the second user, identifying where the first user and the second user have aligned expectations within the matching relationship intent, and sharing the aligned expectations with the first user and the second user.

The present disclosure, in one or more embodiments, further relates to a computer-readable storage medium containing program instructions for a method for self and social discovery, wherein execution of the program instructions by one or more processors of a computer system causes the one or more processors to perform a plurality of steps. This includes developing the profile, wherein developing the profile comprises creating one or more personas, establishing a relationship intent within each persona, and developing expectations within the relationship intent. This further includes identifying where a first user and a second user have a matching relationship intent within a persona, pairing the first user and the second user upon approval for a connection by both the first user and the second user, identifying where the first user and the second user have aligned expectations within the matching relationship intent, and sharing the aligned expectations with the first user and the second user.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1a is a flow chart showing an example of a user's whole self, including a variety of personas, according to one or more embodiments.

FIG. 1b is a flow chart showing another example of a user's whole self, including a variety of personas, according to one or more embodiments.

FIG. 2 is a diagram showing relationship content hierarchy, according to one or more embodiments.

FIG. 3 is a coordinate space combining an economic freedom axis and a personal freedom axis, according to one or more embodiments.

FIG. 4 is a coordinate space combining an orientation axis and a focus axis, according to one or more embodiments.

FIG. 5 is a flow diagram illustrating use of insights gained from survey questions, according to one or more embodiments.

FIG. 6 is a flow chart showing relationship flow in social discovery, according to one or more embodiments.

FIG. 7 illustrates two users' positions in a coordinate space for determining a coherence factor, according to one or more embodiments.

FIG. 8 illustrates two users' positions in a coordinate space for determining an alignment factor, according to one or more embodiments.

FIG. 9 illustrates an overall flow of user activity through a Discovery App, in accordance with one embodiment.

FIG. 10 illustrates a general onboarding process leading a user to registration or login, in accordance with one embodiment.

FIG. 11 illustrates a registration process, in accordance with one embodiment.

FIG. 12 illustrates a login process and a forgot password process, in accordance with one embodiment.

FIG. 13 illustrates editing an account and editing the core of the account, in accordance with one embodiment.

FIG. 14 illustrates the creation and management of personas, in accordance with one embodiment.

FIG. 15 illustrates process flow of surveys and queries, in accordance with one embodiment.

FIG. 16 illustrates a user's process for establishing relationship types within a persona, in accordance with one embodiment.

FIG. 17 illustrates steps in the social discovery and alignment process.

FIG. 18 sets forth expectation comparison, in accordance with one embodiment.

FIG. 19 illustrates protocol behind the DID, in accordance with one embodiment.

FIG. 20 illustrates an example address book using a combination of DIDs and verifiable credentials, in accordance with one embodiment.

### DETAILED DESCRIPTION

The present disclosure relates to novel and advantageous tools for self-discovery and social discovery. In particular, the present disclosure relates to systems and methods for building a virtual representation and analysis of a user's whole self. Additionally, the present disclosure relates to novel and advantageous tools for social discovery for connecting with other users and, specifically, systems and methods for privately testing mutual relationship possibilities and alignments. In some embodiments, the present disclosure relates to systems and methods for seeking and building a social network of other users in a secure environment in which each user maintains ownership of his or her own user data. The systems and methods disclosed herein may be incorporated in an app, referred to herein as a Discovery App.

The Discovery App is designed to help people learn about themselves, connect intentionally, and build deeper relationships with others. People are complex. Using the Persona feature of the Discovery App, users can choose the aspects of themselves that they wish to explore and share. The Discovery App facilitates Self-Discovery, wherein a user may learn about their own personality—their friendship style, their learning preferences, their romantic tendencies—by taking in-depth self-assessments. The Discovery App further facilitates Social Discovery, wherein the user can share their results with others users to connect on commonalities.

The present disclosure includes, in some embodiments, at least first and second phases. The first phase may be referred to as Self-Discovery and the second phase may be referred to as Alignment and Social Discovery. In the first phase, a user may access tools for determining a virtual representation of the user's whole self. That is, a user may use tools for gathering data representative of the user's personality, likes, dislikes, habits, hobbies, preferences, personal and professional relationship goals, intentions, and expectations. In a second phase, a user may access tools for reaching and connecting with other users. For example, the user may allow portions of her or his data to become discoverable to other users. Tools in the second phase may additionally allow users to create secure and verified relationships and networks with other users. The phases may operate consecutively in some embodiments, such that a user may complete the first phase before moving to the second phase. In other embodiments, however, the phases may operate in tandem, or a user may have the option to selectively use either or both phases at any time. Each phase is described in more detail below.

The present disclosure refers to a user's whole self and a user's meta-personas. When presenting oneself to others, people tactically/strategically highlight or submerge relevant traits of their whole self according to the perceptions of the present relationship. The typical way a person presents oneself is a meta-personal approach. That is, a person typically presents different facets of their persona—different personas and intents—based on the other person with whom they are engaging.

Users may use the Discovery App to define and leverage their meta-personas. The Discovery App enables two users to quickly define and safely compare compatibility over a multitude of possible relationships, in parallel if desired. Traditionally, a person may test another person for only one possible relationship type at a time—e.g. Short-term Romance, Best Friends, Casual Chit-Chat, or Study Buddy. Using the Discovery App, a user can review another user's compatibility over a multitude of possible relationship types quickly, safely, and securely. These possible relationship types are referred to herein as Relationship Intents, and help define the broad goals of how two people approach a relationship. In some embodiments, the Discovery App reveals to users only where they align with another user. This provides a starting point for meaningful conversation and connection.

In some embodiments, the system and tools disclosed herein may ensure user ownership of the data. This may be done by using a Self Sovereign Identity (SSI) platform, discussed more fully below. It is to be appreciated that self-discovery, alignment, and social discovery may alternatively done on more traditional platforms.

Lastly, discussion will be made of a user experience through Self-Discovery, Alignment, and Social Discovery using the Discovery App.

Self-Discovery

In a first phase, which may be referred to as a self-discovery phase, tools may be presented to a user for developing a virtual representation of the user's whole self. The user's whole self comprises the deep, holistic, and private values, traits, beliefs, thoughts, expectations, dreams, and experiences that live within an individual's mind. The user's whole self may include indications regarding the user's personality traits, preferences, habits, likes, dislikes, hobbies, goals, and/or other data relating to the user's personas.

The user's whole self may be thought of as the evolving sum of all traits of a user's life in the real world the user's whole self may include a variety of different personas, each persona including identity characteristics within a general context of the user's whole self. For example, a user's whole self may include a Friendship Persona, a Romance Persona, an Academia Persona, and an Industry Persona, as well as many others. Some personas may relate to, or depend from, other personas. In the Discovery app, core profile traits or information may be associated with multiple personas, for example a user's home postal code and birthday may be associated with all of a user's personas.

In general, a user's self-discovery may include discovering tens, hundreds, or even thousands of different personas. In some embodiments, a user may select different personas to define or complete, or decline to complete, as part of the defining the user's whole self. For example, a user may elect to provide data representative of the user's core and industry personas, but may elect not to provide data representative of a friendship persona. In some embodiments, personas may be created automatically based upon data provided by the user.

Systems and methods for secure self and social discovery as disclosed herein may utilize a hierarchy of developing the self to facilitate alignment with others:
Whole Self—the evolving traits that encompass a person.
   Persona—general categories of a person's life (e.g. Romance, Friendship, Learning).
      Relationship Intents—a broad goal two people build a relationship towards. Multiple Relationship Intents may exist in a persona category, in parallel (e.g. “best friends,” “confidant,” “chit-chat”).
         “Must Have” Expectations—firm “deal-breaker” traits a relationship intent must support. A relationship intent may not be easily discovered if two users do not have aligned hard expectations.
         “Nice to Have” Expectations—important traits a relationship intent ought to support.
         “Good to Know” traits—are not critical to the relationship, but are helpful in supporting an intent and/or persona.
         Interest Dimension—a logical grouping of an individual's core traits that can thread across a plurality of relationship types. Traits in a dimension may uplift as an expectation.
            Must Have Expectations may be referred to herein as Hard Expectations. Nice to Have Expectations may be referred to herein as Soft Expectations. It is to be appreciated that alternative embodiments may address Relationship Intents, Must Have Expectations, Nice To Have Expectations, and Good to Know traits differently. For example, a Must Have Expectation trait may not preclude a Relationship Intent discovery if enough Nice to Have Expectation traits align.

Summary Insights may be developed from traits uncovered in self-discovery. For example, Summary Insights may be developed based on Interest Dimensions. Interest Dimensions may have high-level Summary Insights that general compare the overlap of two paired users' dimension traits. Additionally or alternatively, Summary Insight may display information that is good to know but does not overlap with a paired user.

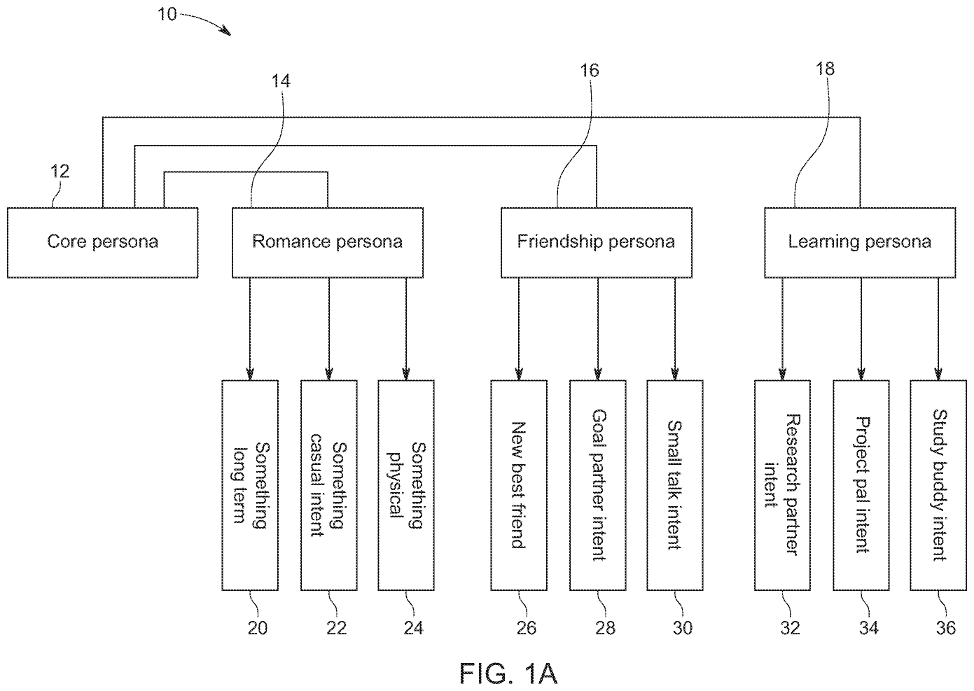

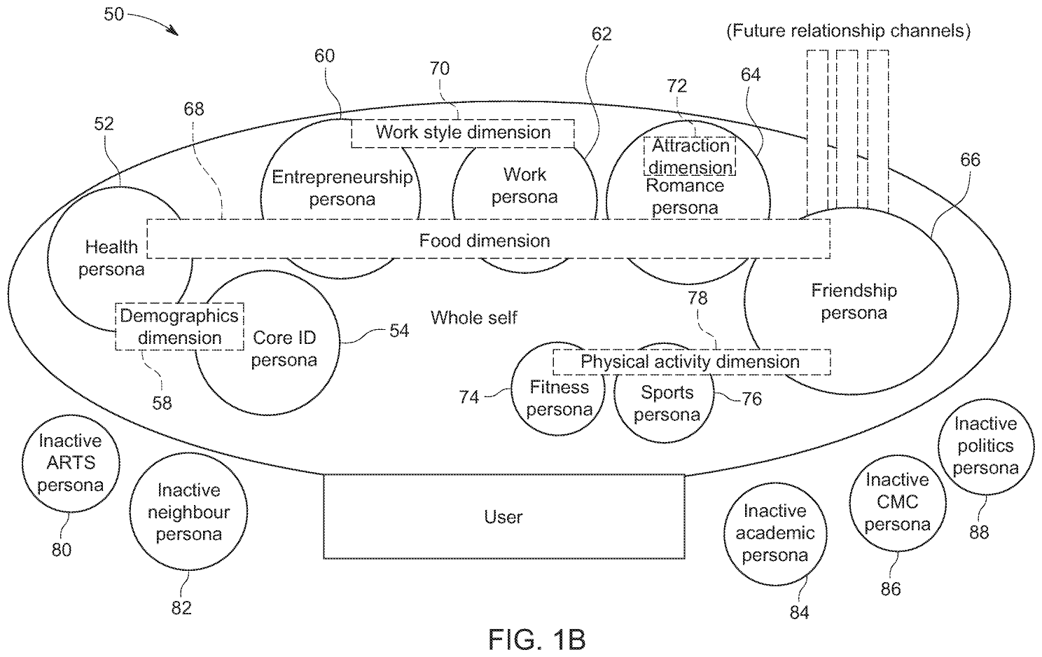

FIG. 1a shows one example of a whole self 10 including a variety of individual personas. It is to be appreciated that the personas shown are illustrative only, and a plurality of other personas exist and may be explorable using the Discovery App. As shown, the user may have a Core Persona 12, which may include core characteristics about the user's personality. Each of the user's other personas may depend from, and thus draw characteristics from, the Core Persona. In this way, core personality traits or preferences about the user that are present in the core persona data may impact the user's other personas as well. In the embodiment shown in FIG. 1a, flowing from the Core Persona 12, the user has a Romance Persona 14, a Friendship Persona 16, and a Learning Persona 18. Relationship intents are present within each persona. For example, as shown, the Romance Persona 14 may have a Some Thing Physical Relationship Intent 24, a Something Casual Relationship Intent 22, and a Something Long-Term Relationship Intent 20. The Friendship Persona 16 may have a Small Talk Relationship Intent 30, a Goal Partner Relationship Intent 28, and a New Best Friend Relationship Intent 26. The Learning Persona 18 may have a Study Buddy Relationship Intent 36, a Project Pal Relationship Intent 34, and a Research Partner Relationship Intent 32. In various embodiments, there may be other personas and other, including fewer, relationship intents within each persona.

In one example, a user may have both a Romance Persona and an Industry Persona. The Romance Persona may include details, traits, preferences, and other data related to the user's desire in seeking a romantic partner. The user's Romance Persona may include both a Something Long-Term relationship intent and a Something Casual relationship intent, each of which may depend from and thus draw characteristics from the romance persona. However, each of the Something Long-Term relationship intent and the Something Casual relationship intent may have different traits, preferences, or other data contained therein, reflecting the user's different preferences in seeking a long-term romantic partner and in seeking a casual romantic partner.

In addition to the Romance Persona, the user may have an Industry Persona, which may include data different than what is contained in the Romance Persona. The Industry Persona may include, for example, an Entrepreneur relationship intent, Career relationship intent, and Mentor relationship intent (not shown in FIG. 1a). Each of these relationship intents may include different data reflecting different preferences or information related to the user's desires and preferences related to the user's career, mentoring, and entrepreneurship. As a particular example, the Career relationship intent may include data related to the user's career path in the user's current industry, while the Entrepreneur relationship intent may include data related to the user's desire or dream to start a business.

FIG. 1b illustrates another example of a user's whole self 50 comprising a variety of personas and dimensions of those personas. For example, the Whole Self 50 includes a Health Persona 52 and a Core ID Persona 54. A demographics dimension 58 overlays the Health Persona 52 and the Core ID Persona 54. The Whole Self 50 further includes an Entrepreneurship Persona 58, a Work Persona 60, A Romance Persona 64, and a Friendship Persona 66. A food dimension 68 overlays the Health Persona, Entrepreneurship Persona, Work Persona, Romance Persona, and Friendship Persona. An attraction dimension 72 overlays the Romance Persona. The Whole Self 50 further includes a Fitness Persona 74 and a Sports Persona 76 with a physical activity dimension 78 overlaying the Fitness Persona, Sports Persona, and Friendship Persona. Some personas may be inactive. Personas may be inactive because a user has not elected to provide data for, or to otherwise active, those personas. In the embodiment shown, the Arts Persona 80, Neighbor Persona 82, Academic Persona 84, Civic Persona 86, and Politics Persona 88 are inactive.

Accordingly, personas may relate to other personas by dimensions. For example, as shown for example in FIG. 1b, each of the user's Entrepreneurship and Work Personas may share a work style dimension. Similarly, each of the user's Fitness, Sports, and Friendship personas may share a physical activity dimension, described more fully below. In this way, the user's preferences, habits, hobbies, and/or other data related to physical activity may be present in, or otherwise affect, each of the user's fitness, sports, and friendship personas.

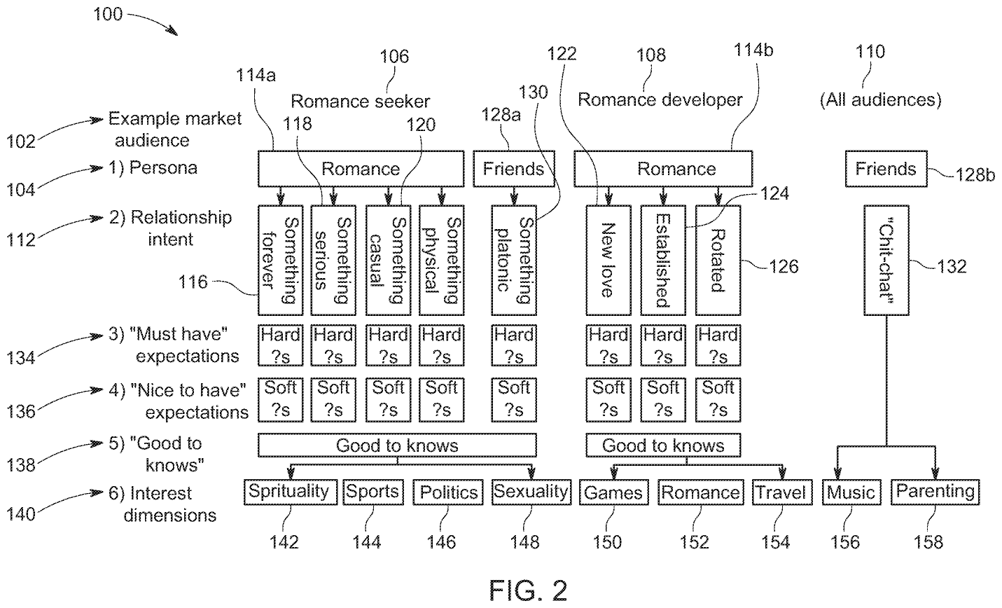

FIG. 2 illustrates a relationship content hierarchy 100, in accordance with one embodiment. Content specifics may be tailored to the Market Audience 102 of each Persona 104. For example, Market Audiences may include Romance Seeker 106, Romance Developer 108, or All Audiences 110. Relevant Personas 104 populate under each Market Audience. And relevant relationship intents 112 populate under each persona 104. While a Persona 104 may be present under more than one Market Audience 102, the associated Relationship Intent(s) 112 may vary based on the Market Audience 102. Thus, the Romance Persona 114a, 114b may be present under the Romance Seeker Market Audience 106 and the Romance Developer Market Audience 108. The Relationship Intents 112 present under the Romance Persona 114a under Romance Seeker 106 may include Something Forever 116, Something Serious 118, and Something Casual 120. In contrast, the Relationship Intents 112 under the Romance Persona 114b under Romance Developer Market Audience 108 may include New Love 122, Established 124, and Rooted 126. Similarly, a Friends Persona 128a, 128b may be present under the Romance Seeker Market Audience 106 and the All Audiences Market Audience. 110 The Relationship Intents 112 present under the Friends Persona 128a under Romance Seeker 106 may include Something Platonic 130. In contrast, the Relationship Intents 112 present under the Friends Persona 128b under All Audiences 110 may include Chit Chat 132.

The exploration aspect may be based on the ability to develop personas and relationship intents to identify alignments. As discussed, under each Relationship Intent 112 a plurality of Must Have Expectations 134, Nice to Have Expectations 136, and Good to Know traits 138 may be developed. Questions or aspects associated with Must Have Expectations and Nice to Have Expectations may be the same or may be different. The user may categorize a specific aspect a Must Have or as a Nice to Have. Good to Know traits 138 may comprise a plurality of Interest Dimensions 140. For example, Interest Dimensions may include spirituality 142, sports 144, politics 146, sexuality 148, games 150, romance 152, travel 154, music 156, or parenting 158. These Interest Dimensions 140 may be explored in any suitable Persona 104 or Relationship Intent 112 and are not generally limited to a single Persona or Relationship Intent. Some Relationship Intents 112 may not have Must Have Expectations or Nice To Have Expectations. For example, in FIG. 2, the Chit-Chat Relationship Intent under the Friends Persona of the All Audiences Market Audience includes only Interest Dimensions.

The Must Have Expectations, Nice to have Expectations, Good to Know traits, and Interest Dimensions are explored and developed using the systems and methods disclosed herein. One tool for collecting data representative of the user's personas may be a survey or a questionnaire. A survey may present one or more questions to the user that are configured to gather and evaluate aspects of the user's whole self. Survey questions may inquire about a user's preferences or traits using a variety of methodologies. For example, survey questions may be binary, asking the user for one of two possible responses (i.e., the user may select yes or no, or in another embodiment the user may select agree or disagree). Other survey questions may provide a continuum, asking the user to rate a level of agreement or disagreement on a scale, such as a numerical scale. Other survey questions may be polyadic, providing a user with a variety of options from which the user may choose one or more responses. For example, a polyadic survey question may ask a user to select from five answer choices, may ask the user to select “up to 3” or up to another number of the five answer choices, or may ask the user to select “all that apply” with respect to the five possible answer choices. Of course a polyadic survey question may provide any other suitable number of answer choices as well. Still other survey questions may be freeform, allowing a user to respond in the user's own words, within suitable constraints such as word limits. Other survey questions may provide a list, allowing a user to select from a list of one or more predefined statements.

Each survey, or a collection of surveys, or other list of questions, may provide insights about individual dimensions, interest dimensions, or personas of the user's whole self or about a user's relationship intents within a persona. For example, a survey may be directed at gathering data about a user's interest dimensions. With specific reference to FIG. 2, Interest Dimensions may include spirituality, sports, politics, sexuality, games, romance, travel, music, or parenting. It is to be appreciated that the personas shown are illustrative only and a plurality of other personas exist and may be explorable using the Discovery App.

One example of an individual dimension is a physical activity dimension. Individual questions may relate to the user's current daily or weekly physical activity level, the user's desired activity level, types of activities the user participates in or in which the user likes to participate, and other information related to the user's physical activity. Data gathered or extracted from the user's survey responses may be used to define at least a portion of the user's fitness persona, sports persona, and friendship persona.

In some embodiments, each survey, or each survey question, may correspond with one or more axes to evaluate the user's responses. An axis may represent a continuum between two opposing positions or extremes. The axis may include values plotted between the two opposing positions. Positions along the axis between the two extremes may correspond with numerical values, for example. A user's survey responses may indicate that the user aligns with a particular position along the axis, between the two extremes. As a particular example, an axis may be a free thinking axis, and may extend between the two extremes of “stay the course” and “ride the wind.” Survey questions may be configured or tailored to determine where the user falls along the free thinking axis, between the two extremes of “stay the course” and “ride the wind.”

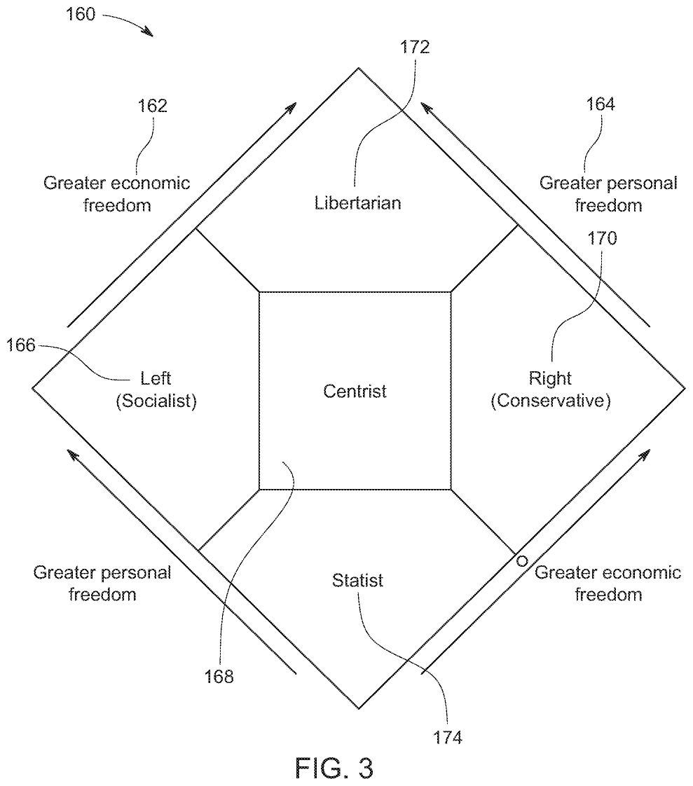

Axes may be grouped to define coordinate spaces. One example of such a coordinate space may be, or may be similar to, a Nolan Chart. FIG. 3 shows one embodiment of a coordinate space 160 defined by two axes—economic freedom 162 and personal freedom 164. Based on pre-defined relationships between the two axes, the coordinate space may be subdivided into individual ideologies, such as left 166, centrist 168, right 170, libertarian 172, and statist 174. A user's position on the personal freedom axis and the user's position on the economic freedom axis may be combined to determine where the user falls within the coordinate space, and thus to determine which canonical subsection(s) or ideology(ies) within the coordinate space the user is most closely aligned with. The user's position within the coordinate space may be used to define a dimension and/or one or more personas of the user and/or one or more relationship intents within a persona. In some embodiments, more than two axes may be combined to create a multi-dimensional coordinate space. As another example, a user's position on a free thinker axis may be combined with the user's position on a drawing skills axis, painting skills axis, and/or sculpture skills axis to create a multi-dimensional space expressing an artistic profile.

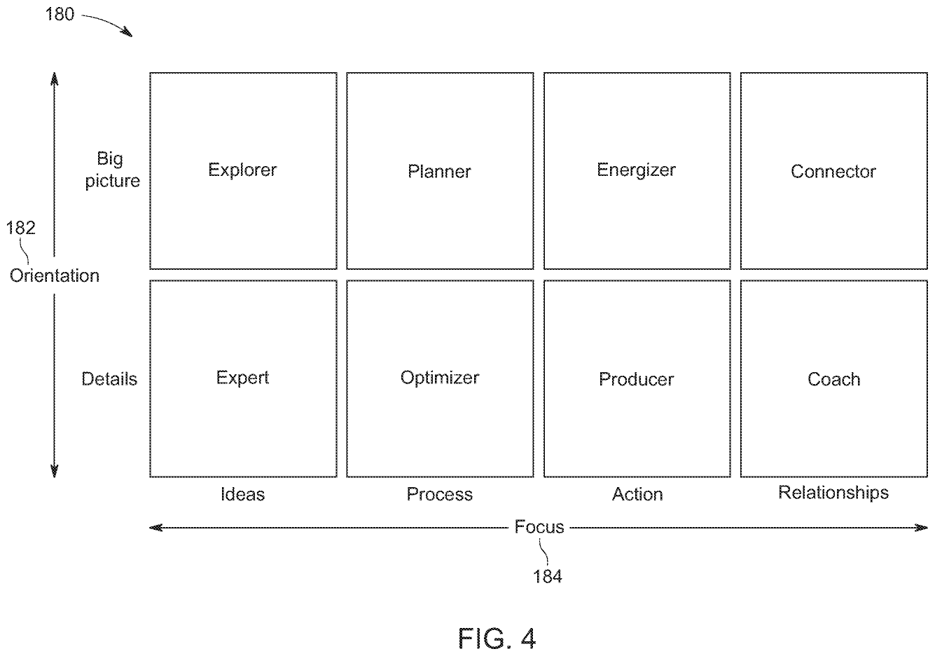

FIG. 4 shows another example of a coordinate space 180. In this embodiment, the coordinate space comprises a workplace thinking style coordinate space defined by orientation and focus axes. As shown, the coordinate space may be subdivided based on known or pre-defined relationships between the two axes. In FIG. 4, the axes are Orientation (y-axis) 182 and Focus (x-axis) 184. The Orientation axis flows between Details (i.e. detail-oriented) and Big Picture (i.e. looks at the big picture). The Focus axis flows from Ideas to Process to Action to Relationships. The relationships of Orientation and Focus result in: Explorer, Expert, Planner, Optimizer, Energizer, Producer, Connector, and Coach. Accordingly, the surveys, survey questions, and questions will result in a characterization of the user as one of these.

In some embodiments, a coordinate space may be defined by other coordinate spaces. That is, for example, a user's plot location within two coordinate spaces may be used to generate a third coordinate space. As another example, surveys and survey questions may be configured to correspond to the axes. For example, surveys and survey questions could correspond to friendliness, gregariousness, cheerfulness, assertiveness, activity level, and excitement-seeking. One coordinate space that may be defined from these axes may be an enthusiasm coordinate space, defined by the friendliness, gregariousness, and cheerfulness axes. A second coordinate space that may be defined by these axes may be an assertiveness space, defined by the assertiveness, activity level, and excitement-seeking axes. A third coordinate space may be an extraversion coordinate space, which may be defined by the enthusiasm coordinate space and the assertiveness coordinate space. To create the extraversion space, the user's data associated with the assertiveness and enthusiasm spaces may be projected onto a one-dimensional axis, for example.

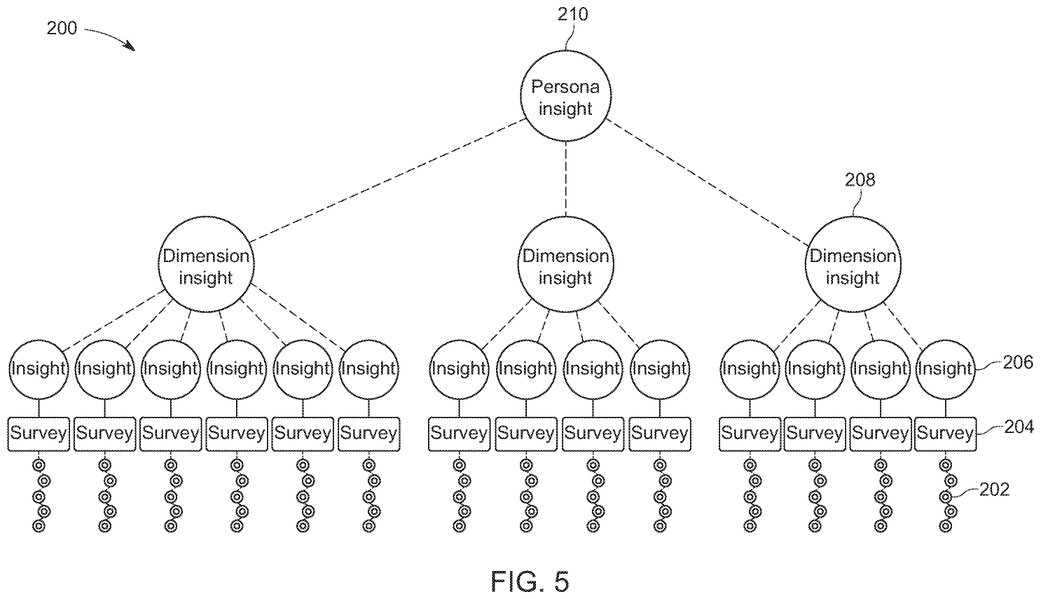

Turning now to FIG. 5, a flow chart 200 is shown demonstrating generally how surveys may be used to develop dimensions and personas. As shown, each survey 204 may comprise a plurality of survey questions 202. Each survey may be tailored or configured to determine an insight 206 about a user. A plurality of insights 206 gained from a plurality of surveys 204 may be combined to determine a dimension insight 208. Insights 208 from one or more dimensions may be combined or grouped to determine a persona insight 210.

FIG. 5 thus illustrate Questions 202 at the bottom. These Questions 202 may culminate in Surveys 204. The Surveys 204 can lead to one or more Insights 206. The Insights 206 may lead to one or more Dimension Insights 208. The Dimension Insights 208 may lead to a Persona Insight 210.

In some embodiments, a survey module may be provided as part of the Discovery App and may be responsible for formulating and/or presenting surveys and/or other self-discovery tools to a user. The survey module may include software and/or hardware for formulating and/or presenting surveys to users. In general, the survey module may pull surveys and survey questions from a survey database. The survey module may select or formulate surveys to present to a particular user based on the user's preferences, based on the user's responses to previous questions, and/or based on pre-defined parameters. For example, the survey module may present a batch of surveys or questions to a user to begin developing the user's core persona and to determine basic information about the user. The survey module may additionally prompt the user to provide a photo, location information, and/or other basic or profile information. Additionally, based on the user's selection of personas to complete, the survey module may present surveys corresponding to those particular personas. Moreover, the survey module may dynamically formulate or present surveys based on the user's responses. The survey module may be configured to evaluate user responses to determine user positions along axes and/or within coordinate spaces.

The survey module may present surveys and/or other data to a user via a user interface, such that the user may interact with the surveys to provide responses through the user interface. The user interface may include, for example, software such as application software. In some embodiments, the user interface may include web-based software. The user interface may be provided to the user via a user device, such may include a smartphone, notebook computer, desktop computer, tablet computer, smart watch, and/or other electronic device.

In some embodiments, a user's data, including the user's responses to survey questions and insights, dimensions, and personas determined or developed from the survey data, may be stored as private data objects in a self-assessment library. The self-assessment library may be, or may include, a database that is selected by the user, and in some embodiments owned and/or maintained by the user. For example, the user's data may be stored locally on the user's device, or may be stored in another local or remote database that is generally owned, maintained, and/or designated by the user. In this way, each use may maintain control over her or his own data, without the need to transfer the data to a third-party for storage or processing. Additionally, user data may be stored in an encrypted form in some embodiments. In some embodiments, the survey module, or portions thereof, may be stored on the user device or otherwise in a database designed, maintained, and/or owned by the user. Through local storage of the survey module, analyses of a user's survey responses, such as to determine where a user fits along an axis, may be performed locally on the user's device. In this way, sensitive user data may be maintained under each user's control.

In some embodiments, a user's data may be stored in the self-assessment library in encrypted form. Each user's encryption keys may be used to decrypt user data. Encryption keys may be stored separately in some embodiments, but still may be owned and maintained by each user.

A content administrator, maintained remotely from the user device, may be configured for updating the survey database and/or for pushing updates to the survey module. It is to be appreciated that the user's data may be maintained entirely separately from the content administrator and the survey database in some embodiments of the first phase, such that the user may maintain control over the user's data.

A user's insights, dimensions, and persona data stored in the self-assessment library may be presented to the user via the user interface. These insights, dimensions, persona data, and other data developed from or related to the user's survey responses may help the user learn more about herself or himself. The user's data may be presented to the user as canonical insights. An example of a canonical insight may be “self-reliant” or “community-minded.” Canonical insights may be used to present user-facing revelations, such as: “You are an independent person who is always up for a challenge. You don't let the small things in life get in your way.”

In general, the more surveys a user responds to, the more complete the user's insights, dimensions, personas, and whole self will be. In some embodiments, a user may need to complete at least a minimum quantity or percentage of surveys or questions associated with an axis or coordinate space in order to obtain an insight, dimension, or persona associated with that axis or coordinate space.

In some embodiments, a user may be required to complete a minimum quantity of surveys or survey questions before moving to the social discovery phase. In some embodiments, the user may be required to complete certain types or categories of surveys or survey questions, or a minimum quantity in certain categories. Moreover, a user may have the ability to proceed to the social discovery phase with respect to one or more particular personas. In such embodiments, the user may be required to complete a particular quantity or percentage of surveys or questions with respect to the one or more personas through which the user wishes to pursue the social discovery phase. Additionally or alternatively, a user may be required to complete other initial requirements before moving to the social discovery phase.

In the second phase, which may be a social discovery phase, the user may have the option to securely share a portion of the user's data so as to connect with other users. Importantly, however, during the social discovery phase, the user may still maintain control and ownership of the user's data. In general, a user may permit access for limited and secure use of the user's data such that a matching module may match the user with compatible users based on user data. The matching module may determine matching users for different types of relationship models, such as friendships, romantic relationships, and professional networking.

Alignment and Social Discovery

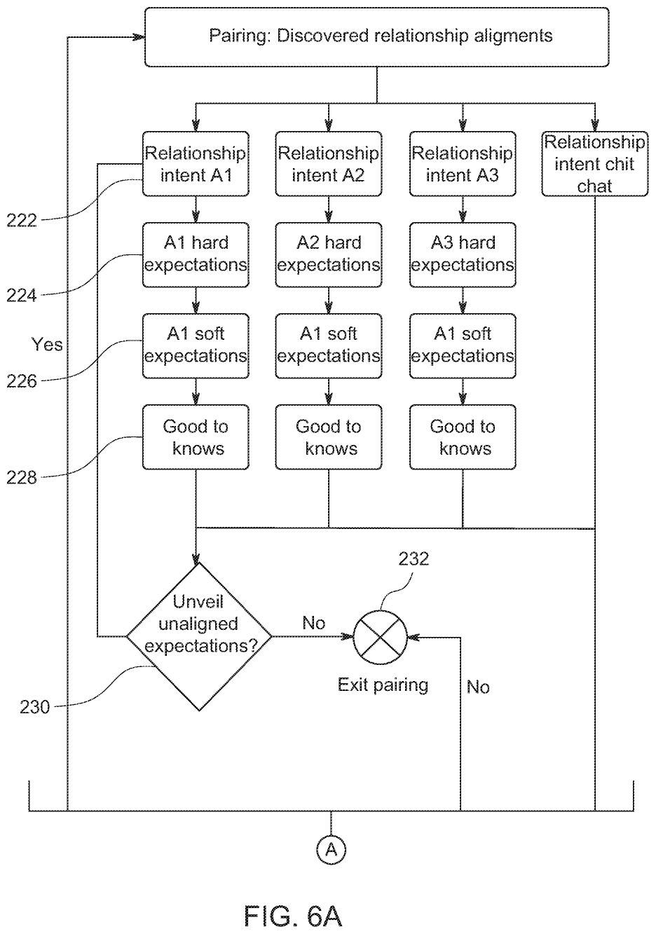

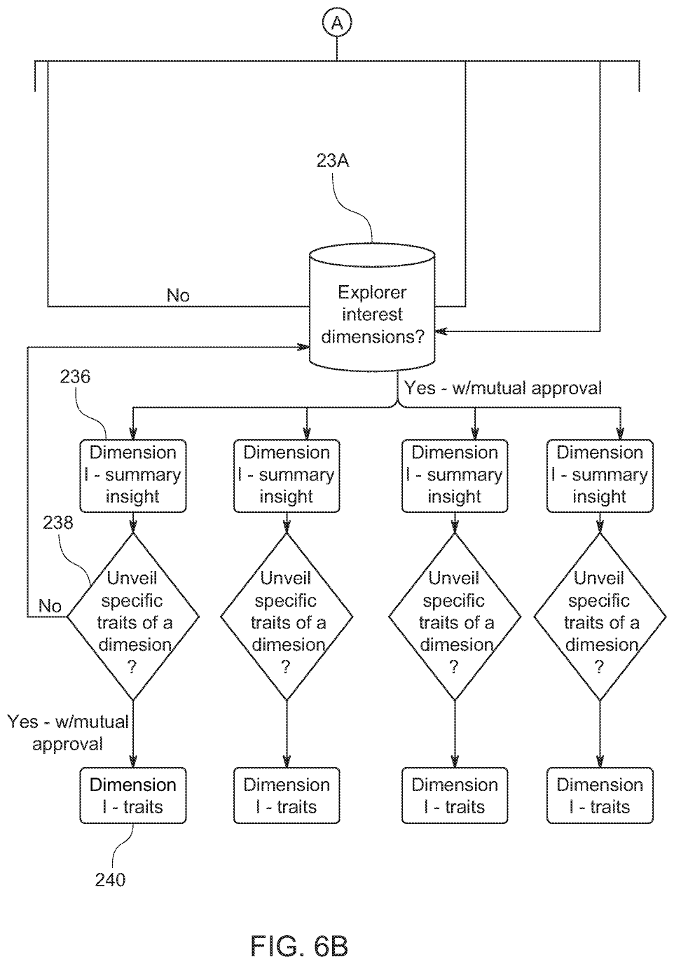

FIG. 6 illustrates a flow chart 220 showing relationship flow, according to one or more embodiments. FIG. 6 focuses on PAIRING: Discovered Relationship Alignments. The process flow looks at a one or more Relationship Intents 222. In the embodiment shown, the process flow looks at four Relationship Intents: Relationship Intent A1, Relationship Intent A2, Relationship Intent A3, and Relationship Intent Chit Chat. For each of Relationship Intents A1, A2, and A3, the system and method looks at alignment of Must Have Expectations 224, Nice to Have Expectations 226, and Good to Know traits 228. These may be presented to a user.

Based on the presented alignments, the user can decide whether to unveil Unaligned Expectations 230. If yes, the process flow returns to the top and reveals the unaligned Must Have Expectations, Nice to Have Expectations, and Good to Know traits. If no, the user has the option of exiting the pairing 232.

If the pairing continues, the user is given the option of exploring Interest Dimensions 234. Dimension examples may include, for example, nutrition, politics, sexuality, or sports. If the user chooses not to explore Interest Dimensions, the user is given the option to exit the pairing 232. If the user choose to explore Interest Dimensions, and the paired user also chooses to explore Interest Dimensions, Summary Insights regarding a Dimension may are unveiled to the other user 236. The Summary Insight is a high-level summary that, in some embodiments, compares the overlap of the paired user's dimension traits.

Based on the Summary Insights, the user may be given the option of unveiling specific traits of a dimension 238. If both users agree to unveil specific traits of a dimension, the dimension traits will be revealed 240. If one or both users do not agree to unveil specific traits of a dimension, the process flow may return to exploring Interest Dimensions of another dimension.

When proceeding to the social discovery phase, after completing at least part of the self-discovery phase, a user may give permission to, for example, an administrator to access the user's data, including the user's survey responses, personas, insights, dimensions, and/or other user data. The user may selectively give permission with respect to data corresponding to particular personas in some embodiments. With the user's permission, the user's data may be used to facilitate discovery or connection with other users, as described below.

Once a user gives permission, or otherwise allows an administrator or other entity to access the user's data, the user's data may be sent or communicated in an encrypted format. User data may be encrypted using encryption keys, which may be stored and/or sent separately from the encrypted user data. In some embodiments, user data may be decrypted only while being acted upon, and may otherwise remain in encrypted form.

User data may be encrypted using encryption keys, which may be stored and/or sent separately from the encrypted user data. In some embodiments, user data may be decrypted only while being acted upon, and may otherwise remain in encrypted form. In one embodiment, user data may first be encrypted on the user's phone (agent), using the user's private key. A corresponding public key is provided to the recipient agent via Sovrin protocols for DPKI (decentralized public key infrastructure). In some embodiments, unencrypted user data may exist only in volatile memory and never persisted.

In some embodiments, a user may set one or more privacy levels for the user's data to which the user will allow access. Privacy levels may affect when and if the user's data becomes viewable or discoverable to others. For example, a user may wish to allow some data to be publicly viewable, allow some data to be viewable only to matched or connected users, and may wish to keep some data hidden. Such data may include particular survey responses, insights, dimensions, personas, or other information about the user.

In the social discovery phase, a user may discover, or become discoverable to, other users in a variety of ways. A discovery engine may determine when and whether users are discoverable to one another based on the users' defined privacy settings and other social discovery parameters. For example, in some embodiments, a user may have or may generate a unique QR code or other computer readable code. Other users may scan the code to access information about the user or to become connected to the user. Alternatively or additionally, geo-location discovery may allow a user to view information about nearby users. Users within a particular range or distance of one another may have the option of connecting. A referral option may additionally allow a user to suggest known users to others for potential connection. A user may generally select one or more personas to be discoverable in different ways or using different discovery modes.

Additionally, in some embodiments, a correlation engine may operate to analyze correlations among users so as to suggest potential user matches. A user may generally select different personas for correlation. For example, a user may wish to receive suggested matches with respect to a business networking persona, but may not wish to receive suggested matches with respect to a romance persona.

The correlation engine may determine matches or suggested matches based on user data, such as survey responses, insights, and dimensions, as well as user-defined parameters, filters, and expectations. For example, a user may wish to form multiple relationships within a particular persona. Each potential new relationship may be defined through relationship channel parameters, filters, and expectations. Within a particular relationship channel, a user may set expectations for the type of relationship that the user is seeking. As an example, the user may select a relationship channel with the expectation that the user is seeking a long-term romantic partner. This expectation may help the correlation engine to match the user with other users who have similar expectations. The user may additionally set filters or other parameters on the type of individual they are seeking within a relationship channel. For example, a user may select particular personality traits, characteristics, hobbies, interests, or other parameters that the user would like to find (or would like to avoid) in a potential match. Another potential parameter or filter may relate to distance or geographic location. A user wishing to make connections with individuals located nearby may designate this via a relationship channel parameter or filter. The Discovery App may be provided with a hyper-local scanning capability such that users who designate such a filter will only match with people who are nearby.

The correlation engine may use a screening step or process to apply a user's expectations, filters, and/or other parameters prior to determining correlations. The screening process may help to narrow the pool of other users with which a match may be made. In addition to screening, the correlation engine may analyze user data using one or more correlation algorithms to determine correlating data among users. In particular, the correlation engine may apply a correlation algorithm within a coordinate space to determine whether users' positions within that coordinate space correlate with one another. Based on a quantity, percentage, type, and/or strength of correlations within various coordinate spaces, the correlation engine may suggest potential user matches.

In some embodiments, a user may have the ability to soften screening parameters or filters. That is, a user may select a softness factor, which may be a percentage, with respect to one or more filters or parameters. For example, a user may select a personality trait as a parameter for desired matches. The user may select a softness factor of 100% for the parameter. Thus, only individuals who have this particular personality trait would be potential matches. However, the user may choose to lower the softness factor to, for example, 50%. With the modified softness factor, the particular personality trait may be considered merely a desirable trait of potential matches, rather than a requirement of potential matches. Softness factors may allow a user to narrow or broaden potential match pools.

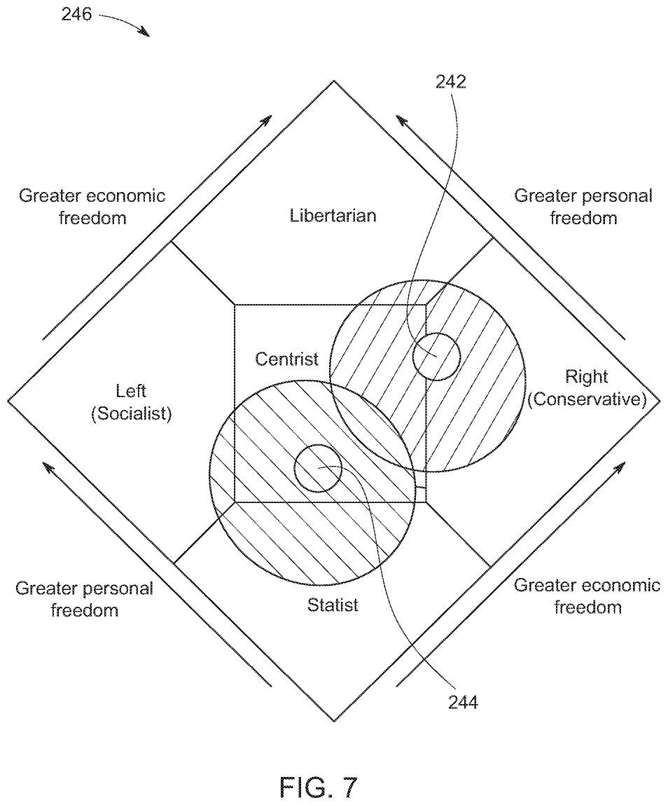

A correlation algorithm may be based on one or more factors. In at least one embodiment, four factors may be used, including agreement, coherence, alignment, and archetype. An agreement factor may be calculated or determined by analyzing whether two users' survey responses contain matching or similar terms. More matching responses may result in a higher agreement factor. This may be particularly applicable with respect to freeform or list survey responses. A coherence factor may examine user positions within canonical subsections of a coordinate space. For example, FIG. 7 shows two users' positions 242, 244 within a coordinate space 246. As shown, a first user 244 may align most with a centrist canonical section, and a second user 242 may align more closely with a right (conservative) section. At first glance, these users may appear to have incompatible canonical viewpoints. A coherence factor may be calculated or determined by determining a distance between each user's position and a center of that respective user's canonical section. Or the coherence factor may be calculated by determining a distance between the two users' positions on the coordinate space.

In general, each user's zone may be defined by the aggregated average (typically mean) of user's survey responses in the subject area. The distance calculation may be the linear distance between the centroid of respective zones. In some embodiments, zone shape may not be considered, and the distance may be the simple distance between each user's aggregated mean location in the subject area.

An “Insight” may occupy a specific location within the subject area, and a user's Insight within that area may be calculated by selecting the Insight with the closest linear distance to the user's aggregated mean. It is also possible to create “tie” Insights, used when the user's mean location is sufficiently similar to more than one Insight.

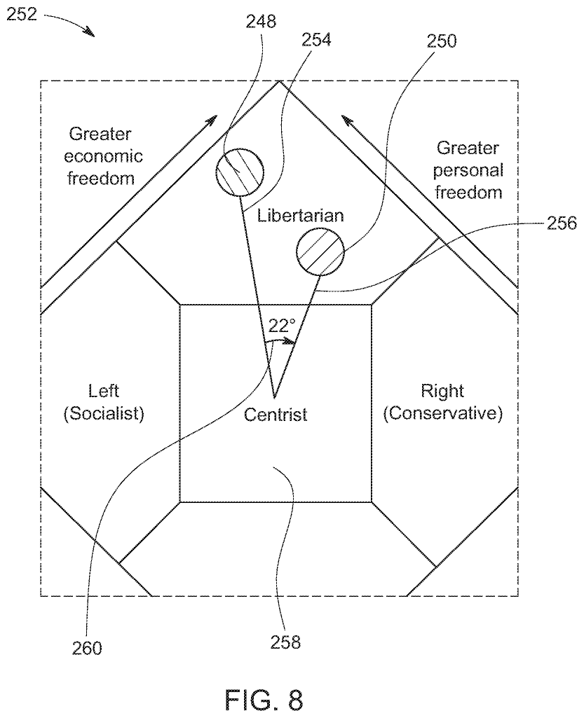

An alignment factor may be calculated or determined based on a cosine similarity between vectors for each use within the coordinate space. For example, FIG. 8 shows two users' positions 248, 250 in a coordinate space 252 and vectors 254, 256 drawn from each user's position to a center 258 of the coordinate space. The alignment factor may include taking a cosine of the angle 260 between the two vectors.

An archetype factor may be calculated or determined based on similarities in users' canonical matches. An archetype factor may involve similarity between two user's calculated Insights within a subject area. For example, if two users had the same Insight from a given subject area, the Discovery App may surmise they have compatibility, even if their aggregated mean locations were not sufficiently proximal to be considered for matching.

The agreement, coherence, alignment, and archetype factors may be combined mathematically to determine a correlation between two users. In other embodiments, alternative and/or additional factors may be used. Correlations may be used to determine particular interpersonal insights. Some examples of an interpersonal insight may be that User A and User B are both politically conservative, that they are diametrically opposed when it comes to foods they like, that they both love fly fishing and kiteboarding, that they both dislike gin drinks, or that they have complimentary yet differing tastes in music.

Once correlations are determined, the correlation engine may provide a list of suggested matches to a user. In some embodiments, interpersonal insights may additionally be presented to a user to provide a more complete picture of why particular individuals are potential matches. When two users are found to have correlating traits, each of the two users may receive an indication of their potential match. In some embodiments, two correlating users may choose to connect with one another. Each of the two users may be required to approve of or permit the connection. Once the users are connected, they may have more view access to each other's information and/or they may have the ability to contact one another.

In some embodiments, users may have levels of visibility or accessibility for potential matches and connections. For example, where the correlation engine determines that two users are potential matches, the users may agree that their mutual compatibilities—that is, traits that they have in common—may be visible to one another. Once the users are connected, both users may agree to reveal non-compatibilities. In some embodiments, both users may need to agree before incompatibilities are revealed. In some embodiments, matched or connected users may additionally agree to a third level of visibility where any otherwise hidden incompatibilities or other hidden data is revealed. In other embodiments, matched or connected users may select or agree to different levels of visibility. In some embodiments, visibility levels may be based on the users' privacy settings and/or other user defined parameters.

In some embodiments, a chat engine may allow users to communicate in real time via text, audio, and/or video. In some embodiments, users may need to be matched or connected before having the option to chat with one another. Additionally or alternatively, users may have the option to accept or deny chat requests. With messaging, users may remotely ask each other to unveil deeper levels of their profile (non-aligned traits, traits users declare a “sensitive,” or other traits). Users may ask to pair on other Intents available to each other, for example, if the hard or Must Have Expectations of those intents align. In some embodiments, if another user's Intent is unavailable to a first user, the two users may mutually opt-in to receive alerts if that Intent ever enters a mutual alignment of Must Have Expectations between those two users.

In some embodiments, a user may accumulate a reputation. For example, a user may develop a reputation within each of the user's discoverable personas. A user's reputation may be a result of trends in the user's usage or behavior, and/or feedback from other users. In some embodiments, a user may have both a canonical reputation and an interpersonal reputation.

User Experience

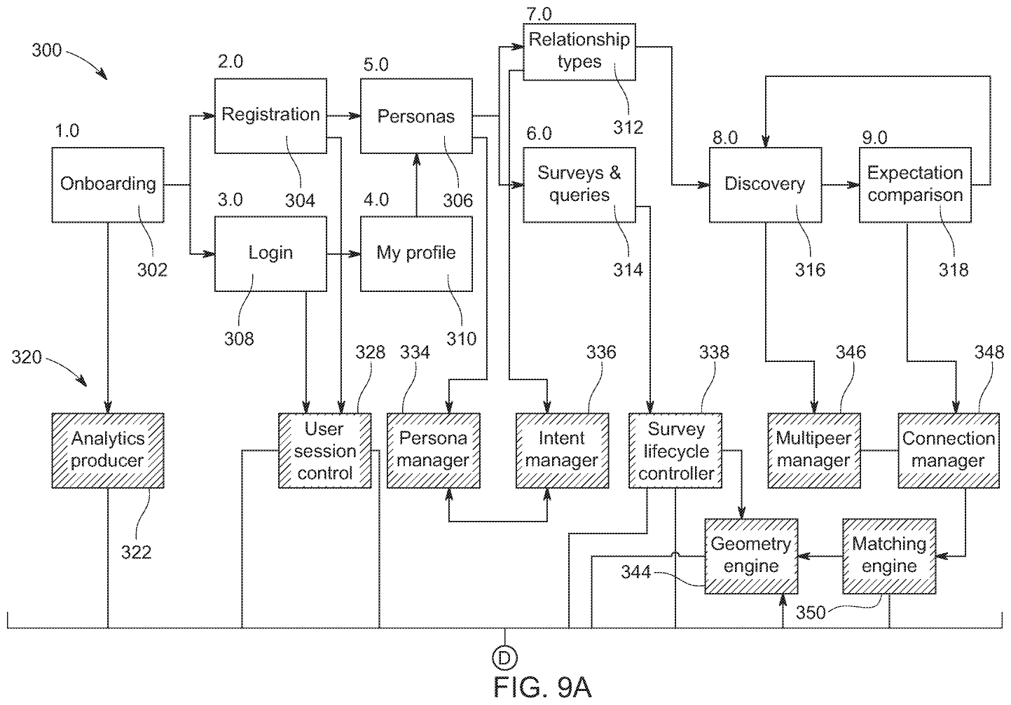

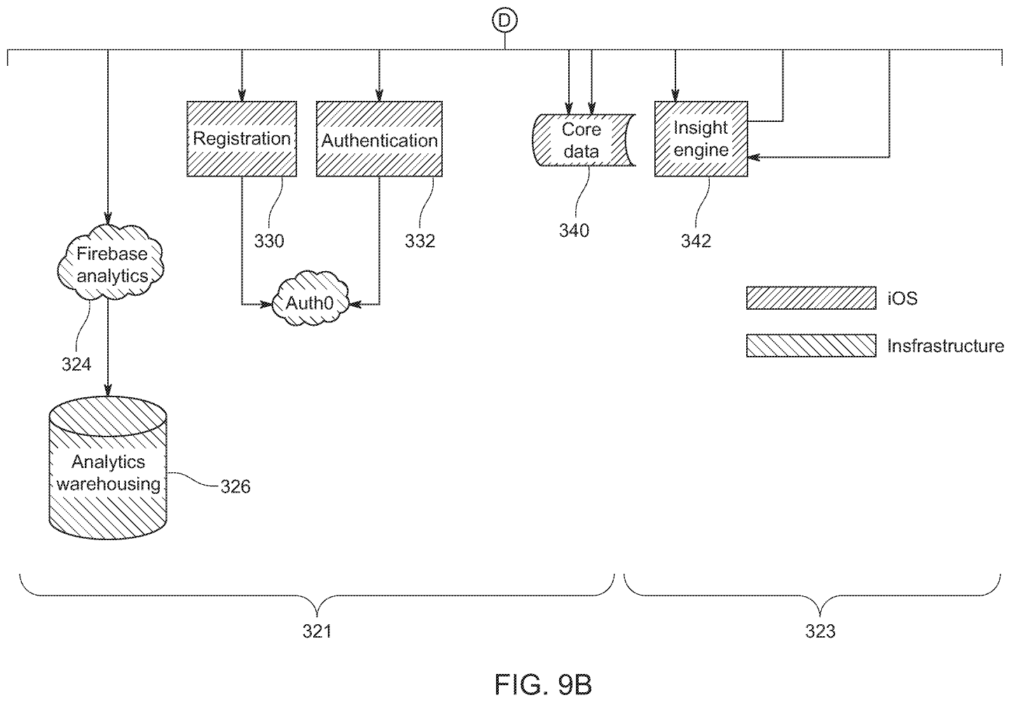

FIG. 9 illustrates an overall flow 300 of user activity through a Discovery App and associated system components 320 for managing the process flow, in accordance with one embodiment. As shown, a user goes through onboarding 302 and registration 304 and then proceeds to developing Personas 306. After initial set up, a user can access the Personas, and further develop existing Personas or select new Personas to develop, via login 308 and selecting their profile 310. Within each Persona, the user selects Relationship Types/Intents 312. The user completes surveys and queries 314 within a Relationship Type to establish Must Have Expectations (or Hard Expectations) and Nice to Have Expectations (or Soft Expectations) within an Intent. The user can enable Social Discovery 316 that will indicate correlating Intents within a Relationship Type. Upon making a connection, connected users can do an Expectation Comparison 318 to determine Alignment.

The system components 320 may be infrastructure or may be on an operating system, such as iOS. The systems managing the Discovery App may vary depending on the platform and specific implementation. Those shown in FIG. 9 are illustrative of one embodiment only and are not intended to be limiting. An analytics producer 322, firebase analytics 324, and analytics warehousing may manage onboarding 302. A user control session 328, registration module 330 and authentication module 332 manage registration 304 and login 308. A persona manager 334 manages personas 306 and an intent manager 336 manages relationship types 312. A survey lifecycle controller 338 manages surveys and queries 314 and works with a core data module 340 an insight engine 342, and geometry engine 344. A multipeer manager 346 manages discovery 316 and a connection manager 348 manages expectation comparison 318. The multipeer manager 346, connection manager 348, matching engine 350, geometry engine 344, and insight engine 342 together function to determine alignments.

The system components 320 may be thought of as existing within a self-discovery module 321 and a social discovery module 323. The self-discovery module 321 comprises the portions of the system related to developing personas and relationship types, including surveys and queries. The social discovery module 323 comprises the portions of the system related to discovery and pairing of users and comparing expectations.

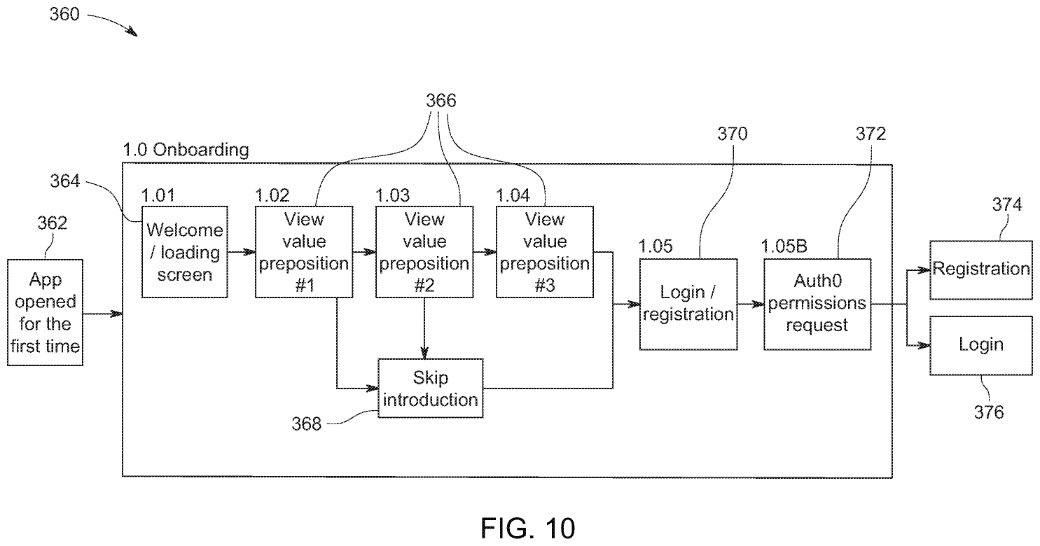

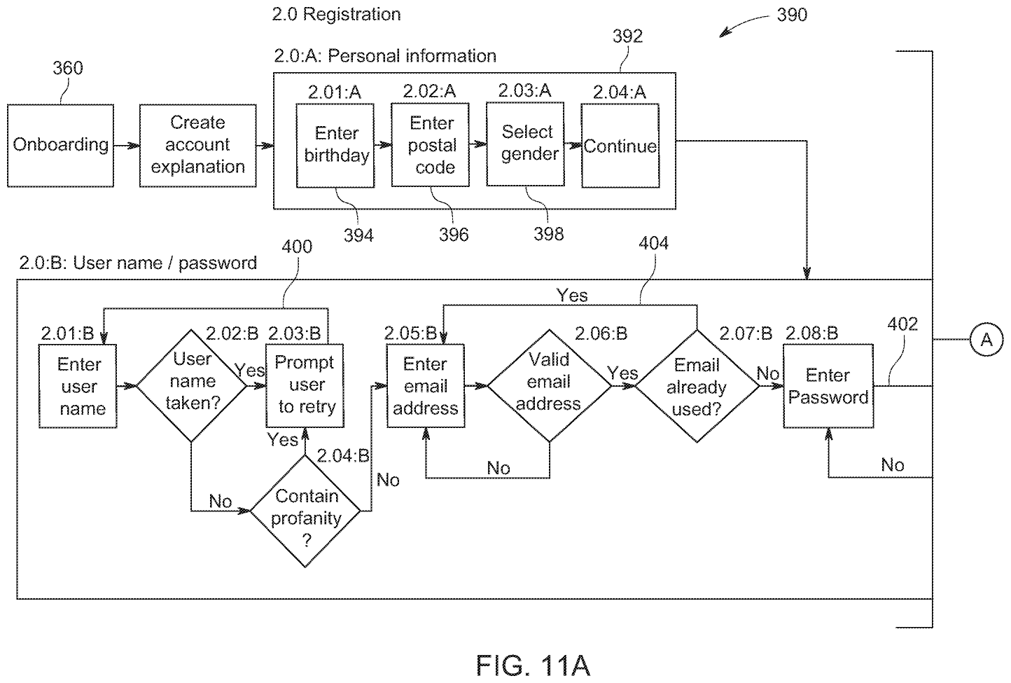

FIGS. 10-18 illustrate the steps of user experience of a system and method according to the current disclosure.

FIG. 10 illustrates a general onboarding process 360 leading a user to registration or login. Upon opening of the Discover App 362, a user is views a welcome/loading screen 364. The user may be shown one or more value propositions 366 or may be given the option of skipping the introduction 368. The user registers or logs in 370. An authentication request is managed 372 before enabling user login. Upon authentication, the user proceeds to registration 374 or login 376.

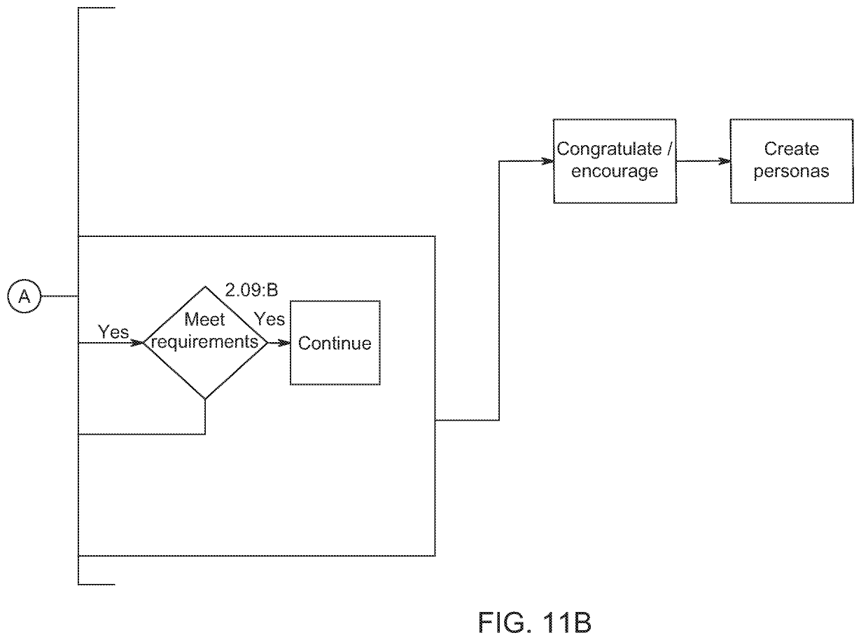

FIG. 11 illustrates a registration process 390. The purpose of creating a profile is to allow a user to manage their own data and content related to their user account and persona relationship expectations. The user enters personal user data 392 relevant to one or more persona categories—such as birthdate 394, sexual identity 396, and postal code 398. The user creates a user name 400, password 404, and associates an email address 402. The user name created may be used in pairing with another user during social discovery.

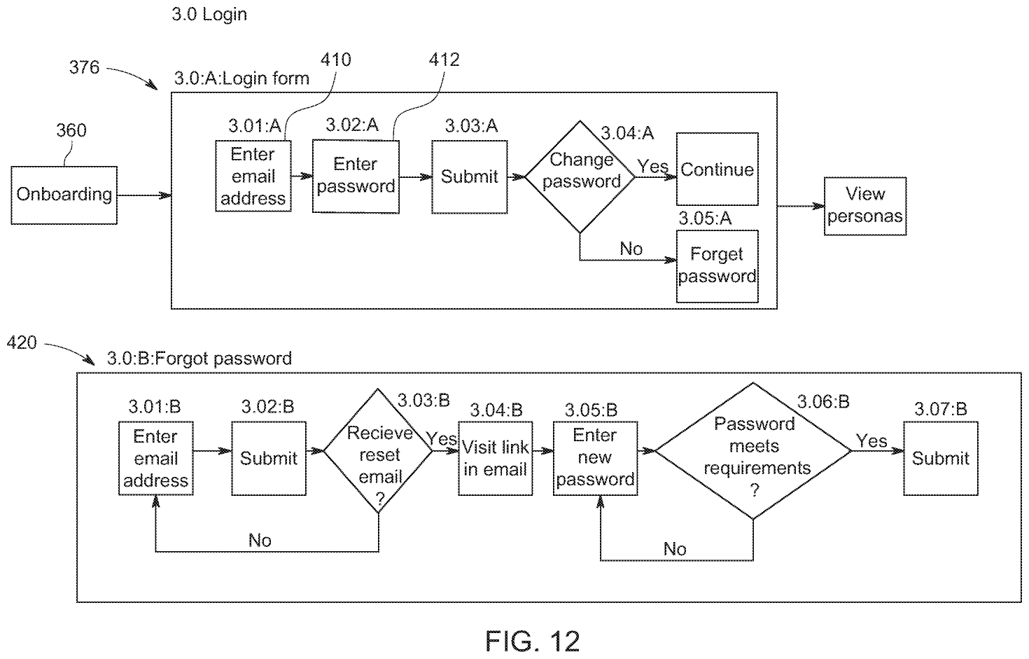

FIG. 12 illustrates a login process 376 and a forgot password process 420. Login 36 generally comprises entering an email address or username 410 and password 412. In an SSI embodiment, login may be done in multiple phases, such as: 1) basic DID-communication and pairing 2) full SSI profiles 3) distributed reputation 4) full SSI passwords and accounts 5) SSI Tokens.

The forgot password process 420 may comprise requesting a reset email and using a link in the email to go to a landing page prompting password reset.

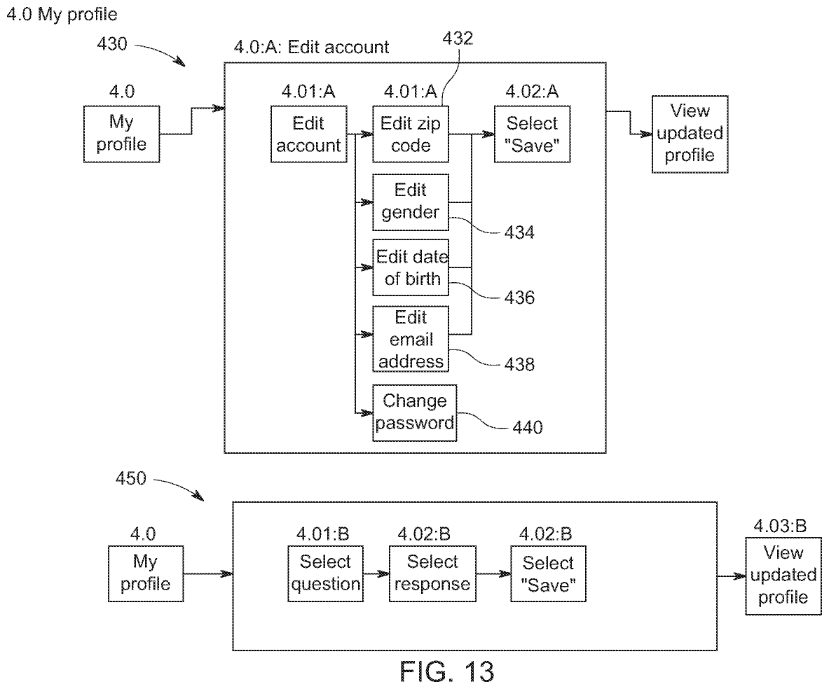

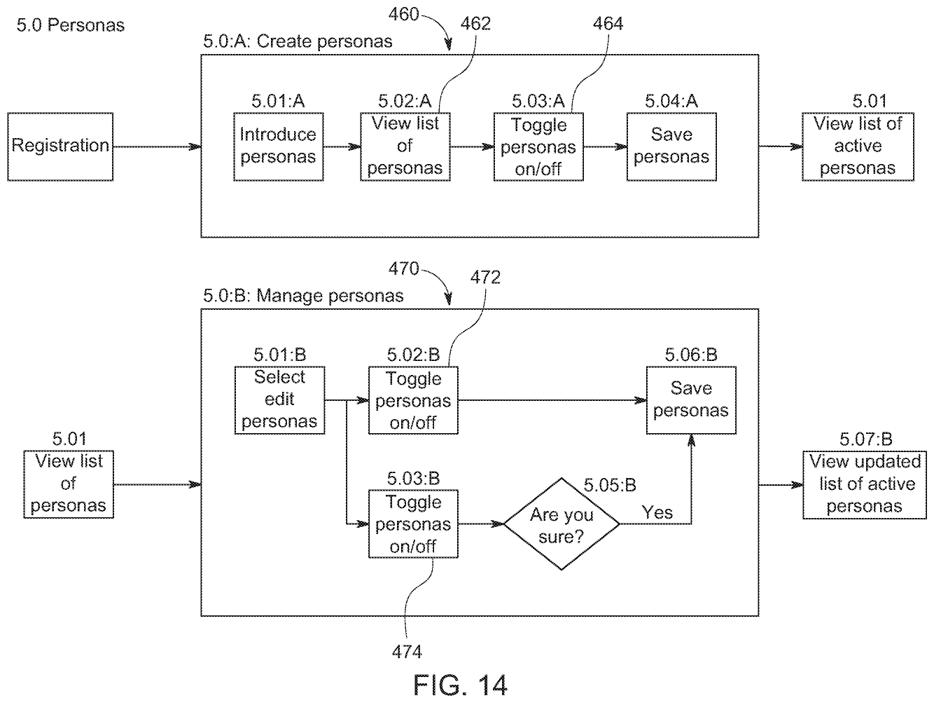

FIG. 13 illustrates editing an account 430 and editing the core of the account 450. Editing the account 430 generally may include editing account information such as zip code 432, gender 434, date of birth 436, email address 438, or password 440. Editing the core 450 may comprise changing responses to queries regarding core traits that branch across all personas and intents—such as birthday, home zip code, gender, and allergies

FIGS. 14-16 relate generally to self-discovery within the Discovery App, in accordance with one embodiment.

FIG. 14 illustrates the creation or personas 460 and management of personas 470. Creation of personas is central to the system and method for self and social discovery. As shown, a user is presented with a list of personas 462. The user then chooses which personas they desire to establish by doing an initial toggle on or off one or more personas 464.

After selecting a persona, the user can manage the personas 470 by toggling personas on and off 472 or by clearing persona data 474. The persona and relationship expectations and intents within a persona are developed by the user, as described herein. When developed, the user may put the persona in “discovery mode” to enable social discovery.

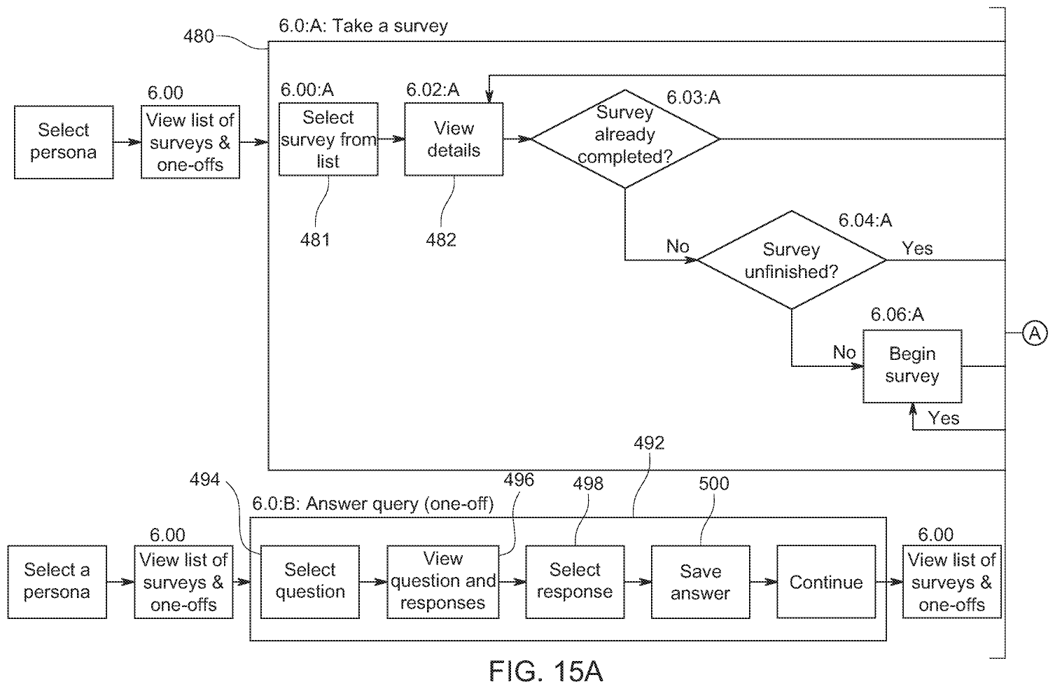

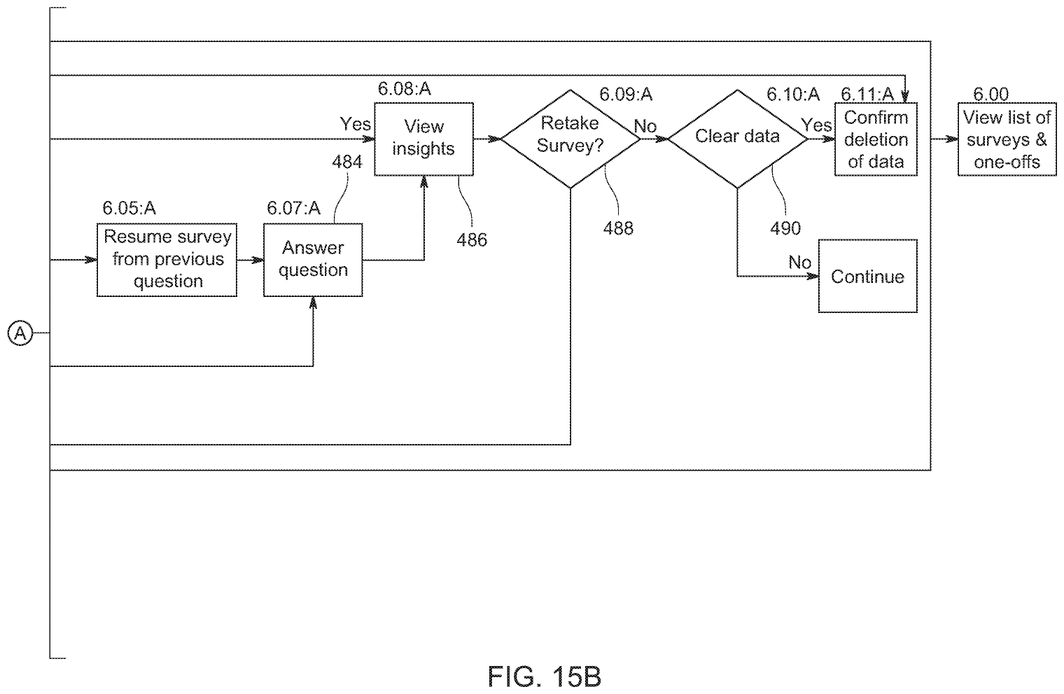

FIG. 15 illustrates process flow of surveys and queries including taking a survey 480 and answering queries 492. The surveys and queries may be used to develop the selected personas. To start answering surveys and queries, the user selects the persona to be developed 481. Upon selection, a list of surveys and one-off queries may be displayed. When taking a survey, the user views the survey details, answers survey questions 484, and views insights based on the answers 486. The user then may be given the option of retaking the survey 488. The user may delete the survey data 490 or may continue with the data based on the survey answers. The user may be given the option of completing the survey at a later time if unable to complete the survey in one sitting. If a user chooses to answer a single query 492, or a one-off, the user selects a question 494, views possible responses 496, chooses their response 498, and saves the answer 500.

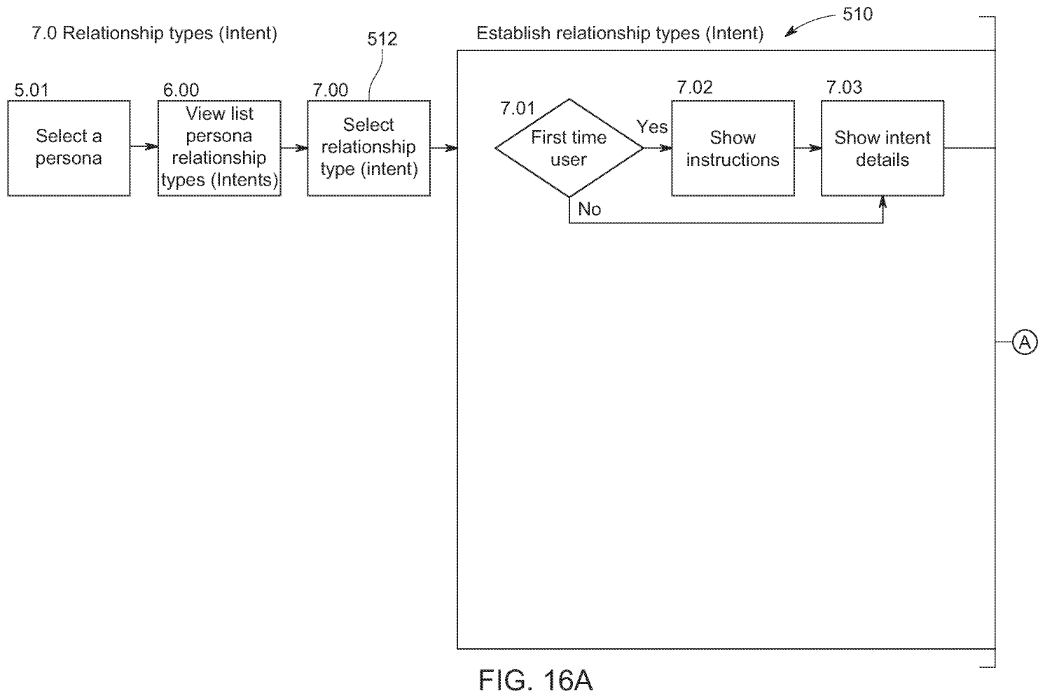

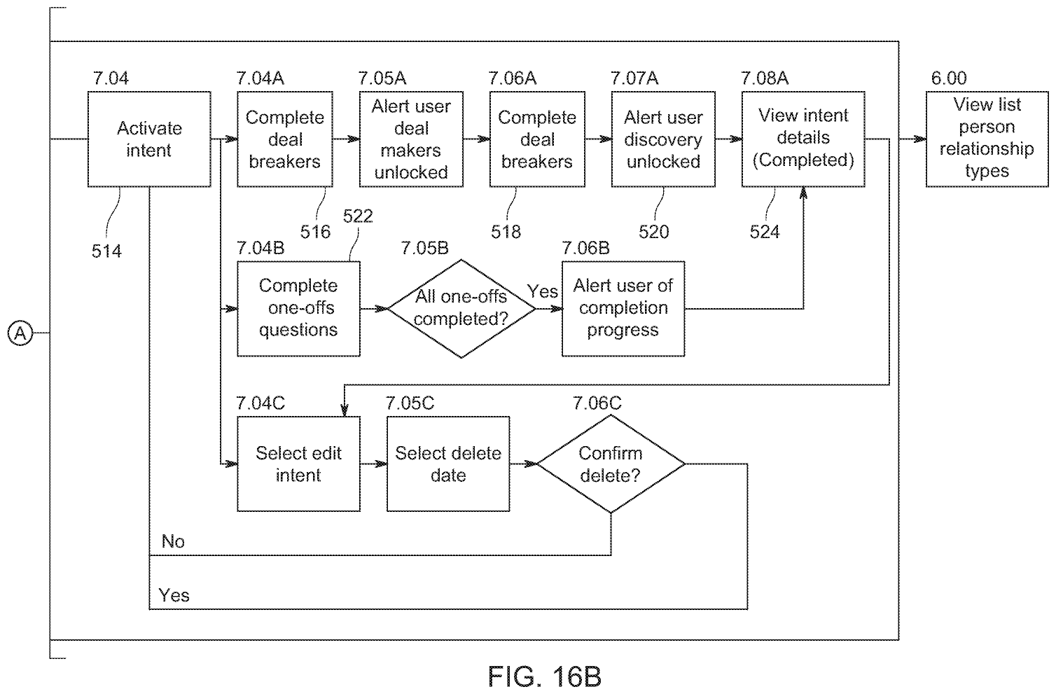

FIG. 16 illustrates a user's process for establishing relationship types within a persona 510. The structure of entering this content is an unveiling process and can be mimicked during the pairing process with another user. Relationship types are a high level in a user experience.

As an initial step, the user selects the persona 512 for which they are establishing a relationship type. Within each persona, there may be intents. The intents establish the basic goals of the relationship intent/type. The user activates the intent correlating with the goal of the selected relationship intent/type of the persona 514. The user establishes Must Have Expectations 516, also referred to as deal-breakers. The user is alerted when deal-makers are unlocked and the user completes the deal-makers 518. After deal-breakers and deal-makers are completed, the user is alerted that a discovery is unlocked 520.

In parallel with the input of deal-breakers and deal-makers, the user may choose to answer one-off questions 522 associated with the intent. The answers to these questions may influence the relationship type intent. Based on the deal-breakers, deal-makers, and one-off questions, Intent Details may be displayed to the user 524.

The user may set Must Have Expectations, or hard expectations, for the relationship type, or for the intent within the relationship type. The Must Have Expectations may generally correlate with the deal-breakers. Must Have Expectations are concepts nested within each intent. It is a limited set of queries that ask users to define “hard stop traits” that start or stop a relationship intention. For example, Must Have Expectations for a Longterm Romantic Relationship Intent may relate to sexual orientation, age, or power dynamics. Must Have Expectations for an Academic Tutor Relationship Intent may relate to availability, subject matter, or in person vs. remote. In some embodiments, users may not be able to pair on an intent if their Must Have Expectations do not align.

The user may further set Nice to Have Expectations, or soft expectations, for the relationship type, or for the intent within the relationship type. The Nice to Have Expectations may correlate with the deal-breakers and the deal-makers. Nice to Have Expectations are expectations that follow Must Have Expectations within an intent but help define boundaries of a relationship intention. Nice to Have Expectations are important traits but ones that are less critical and not automatic deal-breakers. For example, possible Nice to Have Expectations for Short-term Romantic Relationship Intent may include: “Can you drive?” and “Do you smoke?” Possible soft expectations for Friendship Pals Relationship Intent may include: “What sports do you like?” and “What music do you like?”

In addition, information from the surveys and queries of FIG. 13 may be used to influence the relationship type intent. Static trait data content can be set to autopull for pairing or connecting.

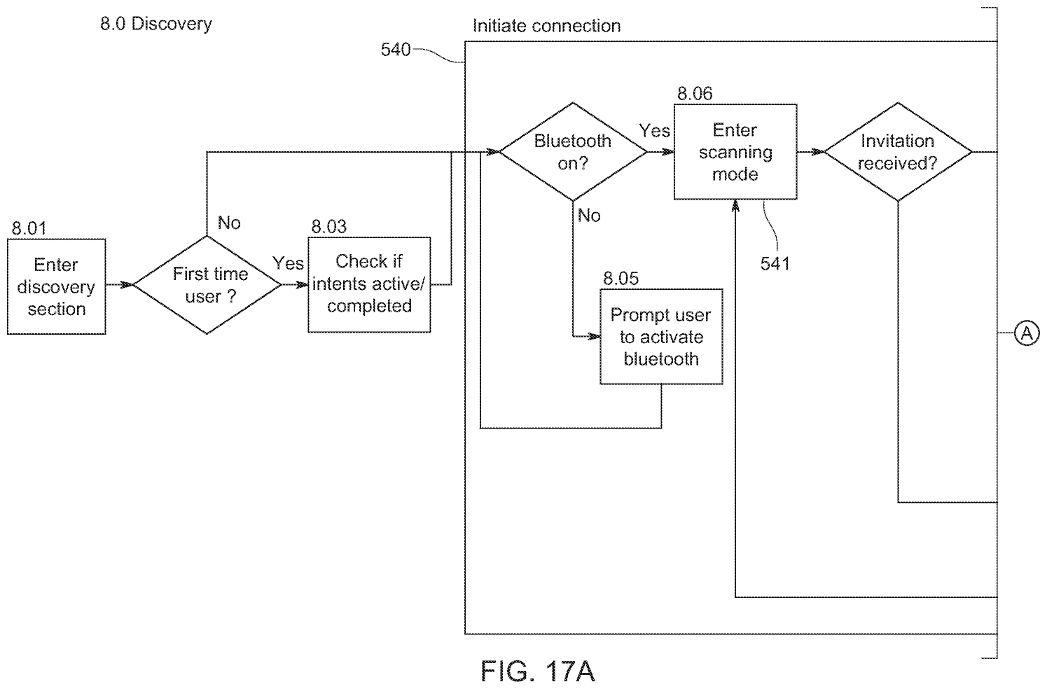

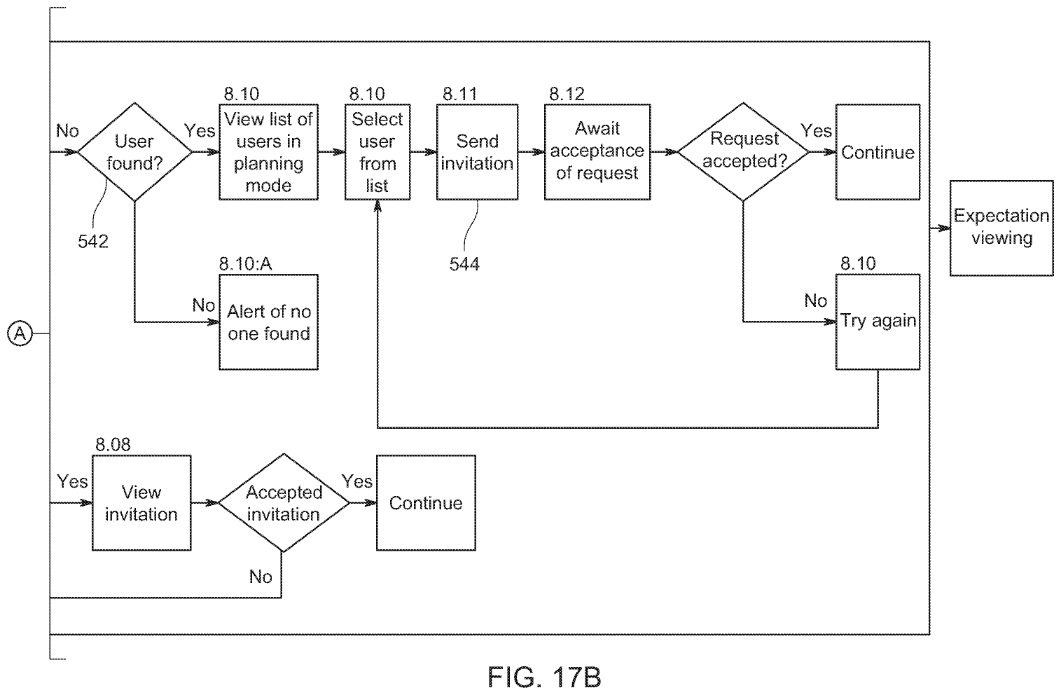

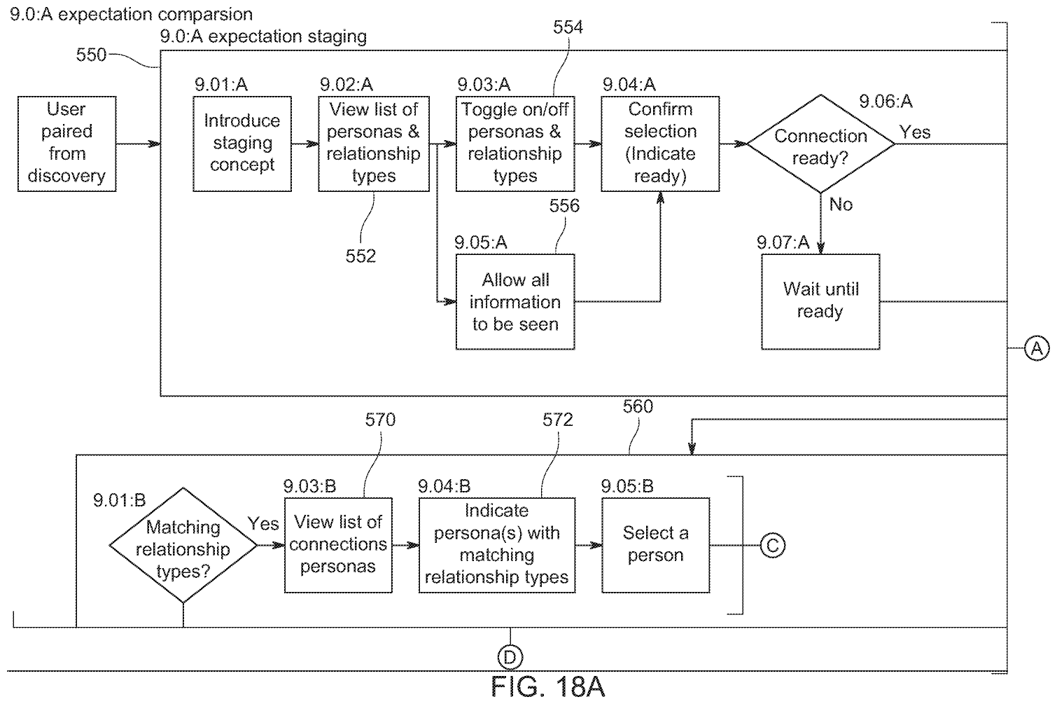

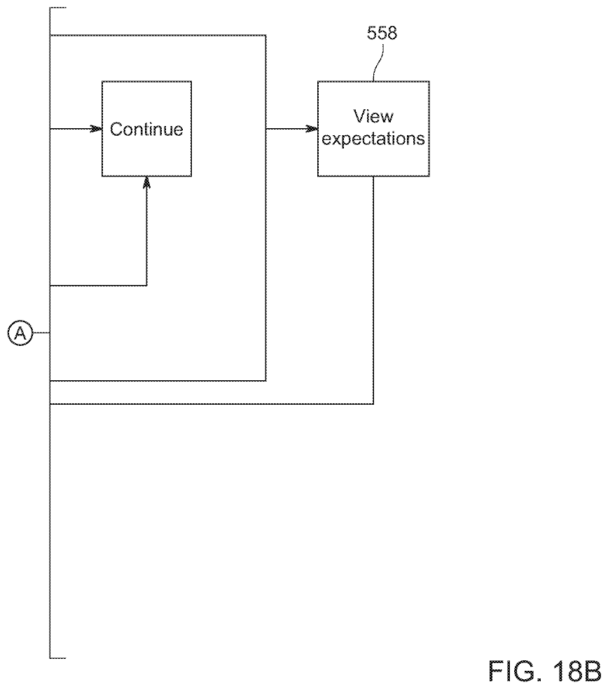

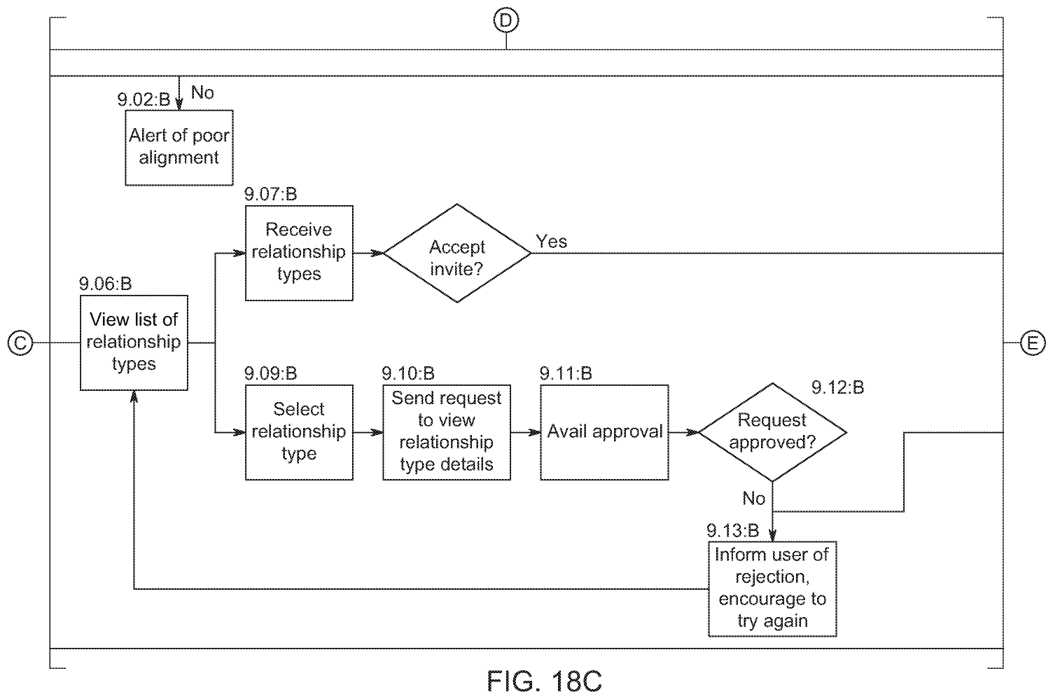

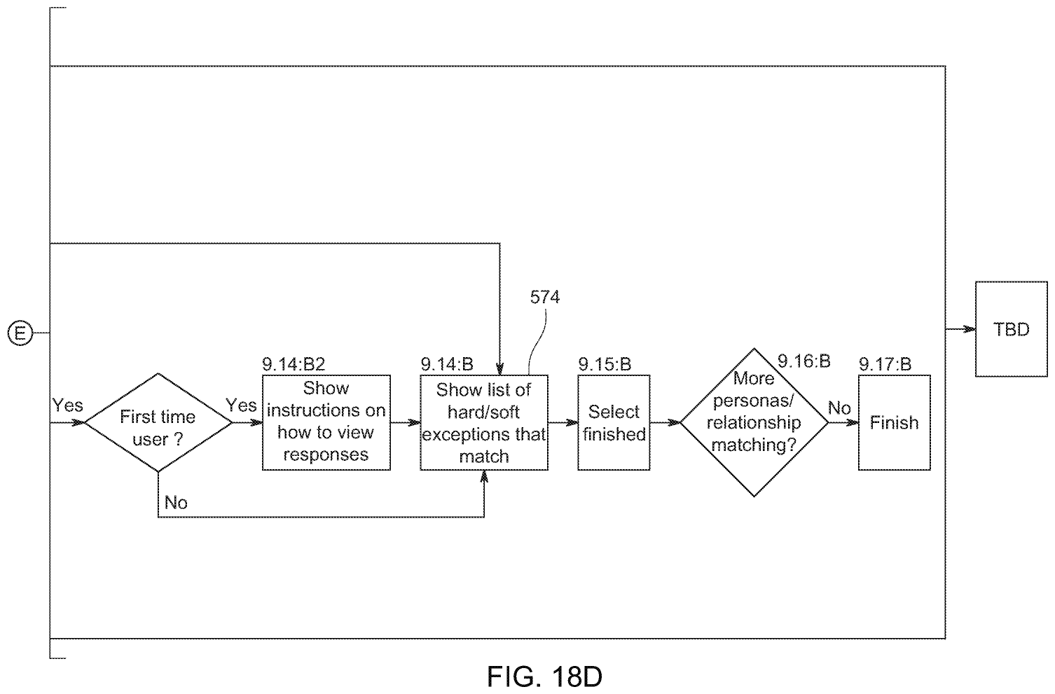

FIGS. 17 and 18 relate to social discovery and alignment. In some embodiments, users may have already discovered one another in person organically. Pairings between two users via the Discovery App, within the In-Person P2P Discovery Method are unique and temporary. Other discovery methods may allow users who have not already met organically face-to-face to review preliminary information before establishing a remote pairing connection that is less temporary.

Social discovery and alignment using the Discovery App culminates in Profile Unveiling to a connected or paired user. Paired users generally experience each other's profiles along a careful progression, and not all at once. In one embodiment, two paired users see aligned Must Have Expectations and Nice to Have Expectations, within a single Intent at a time, on a temporary basis, as is described more fully below (Profile Level I). Either user may seek approval (within an Intent) to view non-aligned expectations (Profile Level II). Eventually, when users trust one another, they have the opportunity to ask/approve viewing within an Intent, any non-aligned traits pre-defined by either user as secret (Profile Level III). Secret traits would have been shown earlier in Profile Level I if they were aligned. Either user may unilaterally rollback profile level depth, or unpair from a relationship Intent altogether, without removing the overall connection between the two users.

FIG. 17 illustrates initiating a connection 540 for the social discovery and alignment process. In some embodiments, social discovery via the system and method for self and social discovery may begin with users having met and talked in person before looking to match on the Discovery App. This process facilitates the initial device to device pairing to connect two people and also initiates the process of connecting on the specific persona. In one embodiment, initial device pairing using in-person or peer-to-peer pairing such as via Bluetooth or WiFi. In other embodiments, any suitable method of device pairing may be used. A user may turn on a mode for viewing other users in a discoverable zone 541. The user may receive and accept an invitation to connect from another user 542 or may send an invitation to connect to another user 544.

In general:
(1) Both users review which Relationship Intents they have available to share.
(2) Both users approve a P2P connection.
(3) Both users may then view Persona categories where their mutual Must Have Expectations within the Intent are aligned.
(4) Both users mutually approve which Intents they would like to unveil.
(5) Both users review one another's mutually aligned Must Have and Nice to Have expectations.
   In some embodiments, no profiles are saved and the users can decide whether to continue in-person engagement based on the unveiling within the Discovery App. In other embodiments, users may save their mutual Relationship Intents as a connection, to later view profile data, unveil deeper levels, and message each other.

In other embodiments, users may have not met in person before engaging in social discovery. The Discovery App may alert the user of potential matches based on a match on at least one relationship type defined by mutual alignments of Must Have Expectations for the relationship intent. Each of a user's Relationship Intents can be independently discoverable to other users, via any suitable device discovery method. Users may independently activate or inactivate a Relationship Intent on multiple discovery methods at once.

Further, a relationship discovery may be based on another user's patterns that align with the user's patterns. For example, an alert may be generated if another user frequents the same establishment as the user. Users may also receive an alert after opting-into “relationship intent tracking,” where two users are nudged together when a user's Relationship Intent newly activates or evolves into alignment, when previously unavailable. In some embodiments, users may manually pair on a Relationship Intent regardless of Must Have Expectation alignment. This allows the users to see where they disconnect in that relationship intent.

Users may connect on one persona at a time. To connect on multiple personas, the users initiate the process of approving each persona. In initial connection screens of the Discovery App, users see the personas for which they have discovery mode, or pairing mode, activated. A list of to the user of other users who have pairing mode activated, who have connected with the user on at least one relationship intent and Must Have Expectation for that persona and relationship intent. These are the only personas that can be matched on. The user can select one of the other users for potential pairing and send an invitation to the other user. If the other user accepts the invitation, the connected users proceed to expectation viewing.

FIG. 18 sets forth expectation staging 550 and expectation comparison 560. Expectation viewing allows users to view mutual Must Have Expectations and view Nice to Have Expectations for specific relationship intents in a specific persona. When paired, users first see where they match on Must Have Expectations and then can decide to view Nice to Have Expectations. This may be referred to as alignment.

Expectation staging 550 is done before expectation viewing and comparison. Expectation staging 550 may comprise viewing a list of personas and relationship types/intents 552 toggling on or off the relationship types/intents 554. The user then may select to have the information be seen 556 and can view authorized information from the paired user 558.

Process flow 560 sets forth viewing of expectations 568. If there are matching relationship intents, a user is given a list of aligned personas 570 and an indication of matching intents within the persona 572. A connection may be made based on the matching intents within the persona. If a connection is made, the user is shown aligned Must Have Expectations and Nice to Have Expectations 574.

Users may choose to unveil deeper levels of a Relationship Intent by mutually approving to view non-aligned expectations traits within the Relationship Intent. Additionally, users may mutually approve to view previously defined secret traits within a Relationship Intent. At any time, either user paired within a Relationship Intent may unilaterally disconnect from the relationship or roll back a level. Two users may pair along many Relationship Intents. Disconnecting from one Relationship Intent does not disconnect from all Relationship Intents shared with that user unless specifically requested by the disconnecting user.

When two users compare their expectations within a Relationship Intent, a thoughtful social Alignment defines the “compatibility” of traits. Often, a similarity between two expectation traits suggests compatibility. Some compatibilities may demand a strict match. Other compatibilities allow for a soft match. Other compatibilities may be based on a connection between opposites (for example, who pays on the first date). It is to be appreciated that compatibility and alignment of traits, expectations, and relationship intents is never a guarantee that: a) traits are 100% honestly defined by each user, b) that these user traits (even if 100% honest) will not change in the future, c) that an aligned Relationship Intent is actually sustainable in the real world outside of the Discovery App, or d) that the Discovery App knows or includes everything that makes a relationship aligned or compatible.

Before individual expectations may be viewed and compared, the user may stage which of their Relationship Intents are available for viewing in a pairing session for a specific other user. To preserve privacy, the staging concept is introduced to enable a user to set what information to share. Each user views their list of Personas and Relationship Intents. They can toggle the Persona and Relationship Intents on or off and can set what information can be seen. The user may be prompted for whether they are ready for the connection to be established.

Once a connection between users is established, the expectations may be viewed. An initial query in seeking a connection is whether there are matching relationship intents. If there is not at least one matching relationship intent, the users are alerted of poor alignment. If there is at least one matching relationship intent, the user is presented with a list of Connections Personas—personas with matching relationship intents. The user selects a persona and views a list of relationship intents within the persona. The user can select a relationship intent and send an invitation to connect, as discussed with respect to FIG. 17. Alternatively, the user may receive an invitation to connect. When a connection is made, the Must Have Expectations and Nice to Have Expectations that match with the connected user are shown in an “unveiling” process. In some embodiments, the user may input other information that may be presented to the connected user during the unveiling process.

Once users have completed expectation viewing, the in-person peer-to-peer discovery process is ended. Users can decide to connect on other personas if they have a connection, or disconnect from the current connection to explore other users to pair with.

In some embodiments, users may mutually choose to save their temporary pairing as a connection, and mutually approve which Relationship Intents to continue connection with outside of the temporary P2P discovery session. Secure communication lines and other advanced profile interactions (and discovery methods) may be possible along each relationship intent held between the two users. Either user may unilaterally disconnect from a Relationship Intent without affecting other Relationship Intent connections shared with that same user.

User Ownership of Data

Discussion now will be made of user ownership and control of the data. This may be achieved, for example, using a Self Sovereign Identity (SSI) platform. It is to be appreciated that in alternative embodiments, the tools for building a virtual representation and or alignment and social discovery may be done on other platforms where user ownership and control of data is not provided.

A central construct to the SSI platform is using unique identifiers for each person with whom a user interacts. In prior technology, all contacts may know a person by the same identifier. For example, by the same phone number. Using SSI, each contact knows the person by a unique identifier. This identifier is a decentralized identifier (DID). In some embodiments, a unique decentralized identifiers (DID) may be assigned to each user relationship. A DID may include a numerical or alpha-numerical identifier. DIDs may be generated, in part, using a hash function, and may be added to a blockchain ledger. For example, the DID may comprise:

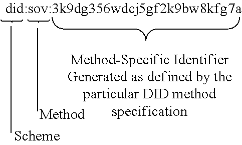

Each relationship or connection between users may be associated with a unique DID. Each DID may be a two-party lifetime encrypted communication channel that does not rely on a third party.

In general, DIDs establish secure and private connectivity between two parties. Every relationship uses a different encryption key as well as a different DID. These may be created automatically when a user adds a new contact. The user owns their own keys. DIDs are trustworthy because of what the person/organization/thing on the other side can prove about themselves. Using a DID, a user is not just able to prove their identity but also to exchange verifiable digital credentials.

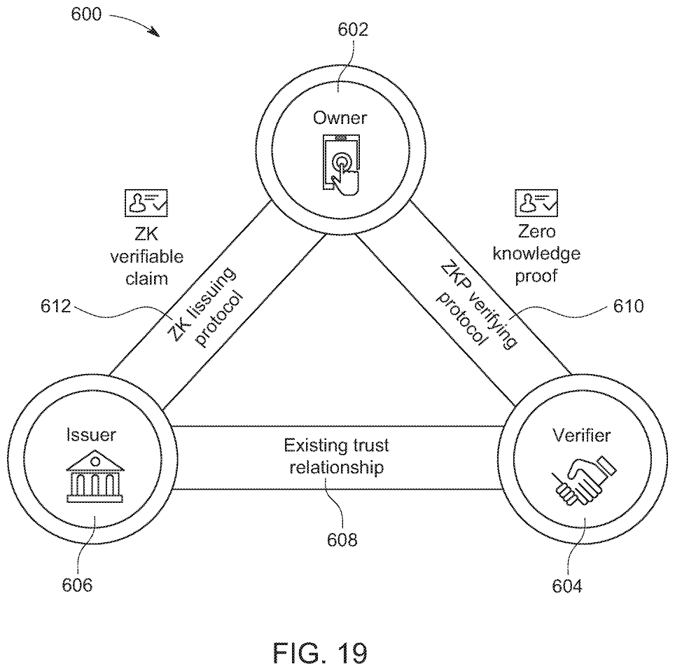

FIG. 19 illustrates protocol 600 behind the DID, in accordance with one embodiment. There is an Owner 602, a Verifier 604, and an Issuer 606. The Verifier 604 and Issuer 606 have an existing trust relationship 608. ZKP Verifying Protocol 610 is used between the Owner 602 and the Verifier 604. ZK Issuing Protocol 612 is used between the Issuer 606 and the Owner 602. There is no central registration authority. Every DID is registered directly on a blockchain or distributed network.

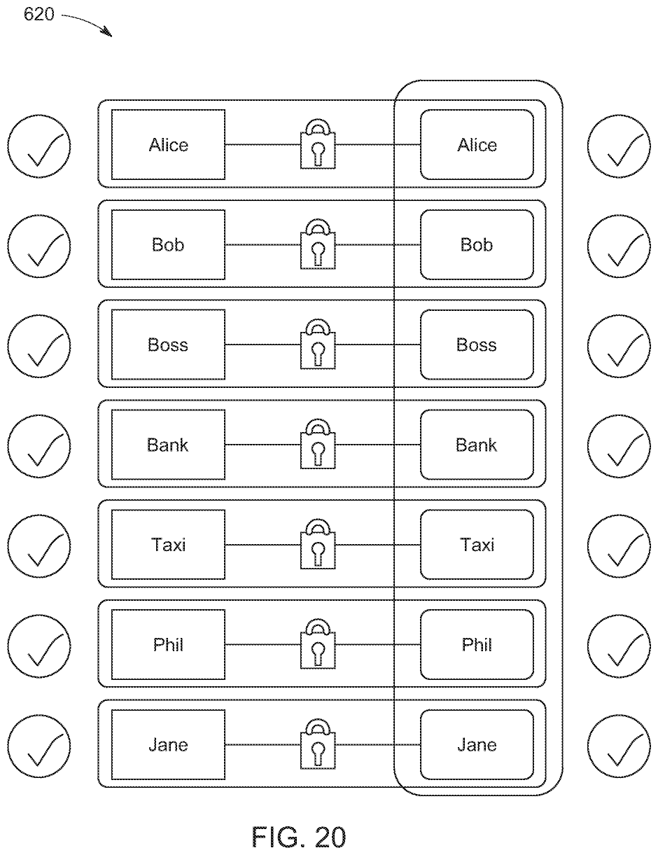

FIG. 20 illustrates an example address book 620 using a combination of DIDs and verifiable credentials, in accordance with one embodiment. The combination of DIDs plus verifiable credentials provides a way to establish connectivity, security, and trust. No middle-man or connection broker is required. This establishes a communication protocol similar to a VPN (virtual private network) with each contact with the ability for users to mutually authenticate each other. Selective Disclosure and Zero-Knowledge Proofs are built in. A record of what is shared with whom and when is stored.

User private information may not be stored on the Discovery App. Users may use keys that only they control to prove ownership over their devices, their data, and their relationships. Identity owners can prove ownership over ownership over Credentials and DIDs with their keys, such as a verkey and a private key. Users can use these same keys to login to the Discovery App without username or password. Identity owners can use their DID with the Discovery App to login by proving ownership of keys. The verkey can be attached to a biometric such as fingerprints. Further, users' friends and family can recover an account when keys are lost or stolen. Social key recovery relies on trustee recovery policy when is managed by the User.

It is to be appreciated that with respect to systems and methods described in the present disclosure, each user may own and maintain control over the user's data. This includes maintaining control over sensitive information and user-created data. With users storing and authenticating their own data, a risk of data breaches may be significantly reduced, as compared with systems and methods in which users do not own their own data or where user data is maintained in a central database. Moreover, empowering users with data autonomy may greatly reduce the users' digital footprints. By allowing users to interact using non-correlatable DIDs, the users may interact online without frequently sharing their personal names, contact information, and/or other personal information. Additionally, user-controlled data allows users to determine access rights of others. In contrast to systems and methods that frequently monetize user data without their knowledge or express consent, in systems and methods of the present disclosure, users may have the ability to allow or refuse access or use of their data. Moreover, users may have the ability to revoke access to their data at any time. For example, a user may be given the option of opting out of Discovery App analytics. In some embodiments, shared user data may be erased from a paired user's access once a P2P connection is made (described more fully below). Using an SSI platform, a user can remain anonymous while connecting with strangers. The Discovery App uses information to build a User profile. From User Insights, the Discovery App can generate Zero Knowledge Proofs (shared via Agent-to-Agent communication such as DID. This attests to various aspect of a User's data without actually sharing the private data. The Discovery App can collect metadata about the User in a private way—including Location, IP Address/Mac Address, and Discovery Preferences. This information can be sent via private encrypted Agent-to-Agent communication (DID).

An SSI platform is compatible with all discovery methods, including code connect. Users can skip discovery opt-in (discussed below) and connect directly with another person using an auto-generated private communication channel. Using QR codes, a new DID can be generated that allows users to immediately share a private encrypted channel with whomever they want.

SSI enables private, controlled communication between users (once users are connected). Users can mutually consent to their relationships and communicate P2P. DIDs are 2-party lifetime encrypted communication channels that do not require a third party to access. DIDs can be used to send credentials, proofs, and messages. Both parties have to mutually consent to the relationship. SSI is more secure than the current industry standard of end-to-end encryption. End-to-end encryption requires a third party server. P2P using DID does not require a third party server.

Using an SSI platform, users can have multiple Personas which are not correlatable. There may be pairwise DIDs for every relationship. Users may be permitted to indicate what information they want to share and at which phase, without the Discovery App seeing the information.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of a system may include one or more disk drives or one or more mass storage devices, one or more network ports for communicating with external devices as well as various input and output (I/O) devices, such as digital and analog general purpose I/O, a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. A system may include what is referred to as a user interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, buzzer, bell, and/or other user input/output device for communicating with one or more users or for entering information into the system. These and other devices for interacting with the system may be connected to the system through I/O device interface(s) via a system bus, but can be connected by other interfaces such as a parallel port, IEEE 1394 serial port, a game port, a USB port, an IR interface, etc. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices.

A system may also include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, I2C, SPI, USB, etc.) using any of a variety of commercially available bus architectures.

One or more programs or applications, such as a web browser and/or other executable applications, may be stored in one or more of the system data storage devices. Generally, programs may include routines, methods, data structures, other software components, etc., that perform particular tasks or implement particular abstract data types. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A user may interact with the system, programs, and data stored thereon or accessible thereto using any one or more of the input and output devices described above.

A system of the present disclosure can operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices.

Hardware and software components of the present disclosure, as discussed herein, may be integral portions of a single computer, server, controller, or message sign, or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, the nearness of completion will be so as to have generally the same overall result as if absolute and total completion were obtained. The use of “substantially” is equally applicable when used in a negative connotation to refer to the complete or near complete lack of an action, characteristic, property, state, structure, item, or result. For example, an element, combination, embodiment, or composition that is “substantially free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A method for social discovery comprising:
providing a platform on which a user can develop a profile, wherein developing the profile comprises:
creating one or more personas;
establishing a relationship intent within each persona;
developing expectations within the relationship intent;
identifying where a first user and a second user have a matching relationship intent within a matching persona;
pairing the first user and the second user upon approval for a connection by both the first user and the second user;
identifying where the first user and the second user have aligned expectations within the matching relationship intent;
sharing the aligned expectations with the first user and the second user.

2. The method of claim 1, further comprising identifying non-aligned expectations and sharing non-aligned expectations with the second user when the first user elects to share the non-aligned expectations with the second user.

3. The method of claim 1, further comprising sharing mutually approved expectations when the first user and the second user mutually approve sharing expectations within a relationship intent.

4. The method of claim 1, wherein the one or more personas are at least two of a romance persona, a friendship persona, a learning persona, and an industry persona.

5. The method of claim 1, wherein creating each persona comprises answering questions relating to the persona.

6. The method of claim 5, wherein the questions relate to more than one persona.

7. The method of claim 1, wherein creating each persona comprises answering surveys relating to the persona.

8. The method of claim 1, wherein the expectations comprise Must Have expectations.

9. The method of claim 8, wherein a first user and a second user cannot be paired if their Must Have expectations are not aligned.

10. The method of claim 1, wherein the expectations comprise Good to Have expectations.

11. The method of claim 1, further comprising developing interest dimensions within a relationship intent.

12. The method of claim 1, further comprising developing summary insights based on the expectations within a relationship intent.

13. The method of claim 1, wherein the one or more personas are each created under a market audience and wherein relationship intents under each persona are tailored to the market audience.

14. The method of claim 13, wherein a persona may exist under more than one market audience and wherein the relationship intents for that persona are different based on the market audience.

15. A system for self and social discovery, the system comprising:
a self-discovery module for facilitating self-discovery and including a persona manager and an intent manager, wherein the self-discovery module facilitates:
creating one or more personas;
establishing a relationship intent within each persona; and
developing expectations within the relationship intent;
a social discovery module for facilitating social discovery and including an insight engine, a matching engine, and a connection manager, wherein the social discovery module facilitates:
identifying where a first user and a second user have a matching relationship intent within a matching persona;
pairing the first user and the second user upon approval for a connection by both the first user and the second user;
identifying where the first user and the second user have aligned expectations within the matching relationship intent; and
sharing the aligned expectations with the first user and the second user.

16. The system of claim 15, wherein the expectations comprise Must Have expectations. 17, The system of claim 8, wherein a first user and a second user cannot be paired if their Must Have expectations are not aligned.

18. A computer-readable storage medium containing program instructions for a method for self and social discovery, wherein execution of the program instructions by one or more processors of a computer system causes the one or more processors to perform steps comprising:
developing the profile, wherein developing the profile comprises:
creating one or more personas;
establishing a relationship intent within each persona;
developing expectations within the relationship intent;
identifying where a first user and a second user have a matching relationship intent within a persona;
pairing the first user and the second user upon approval for a connection by both the first user and the second user;
identifying where the first user and the second user have aligned expectations within the matching relationship intent;
sharing the aligned expectations with the first user and the second user.

19. The computer-readable storage medium of claim 18, wherein the expectations comprise Must Have expectations.

20. The computer-readable storage medium of claim 18, wherein a first user and a second user cannot be paired if their Must Have expectations are not aligned.
